(19) United States
(12) Patent Application Publication
(10) Pub. No.: US 2017/0262382 A1
(43) Pub. Date: Sep. 14, 2017

(54) PROCESSING DEVICE, INFORMATION PROCESSING APPARATUS, AND CONTROL METHOD OF PROCESSING DEVICE

(71) Applicant: FUJITSU LIMITED, Kawasaki-shi (JP)

(72) Inventors: Seishi OKADA, Kawasaki (JP); Jin TAKAHASHI, Kawasaki (JP)

(73) Assignee: FUJITSU LIMITED, Kawasaki-shi (JP)

(21) Appl. No.: 15/444,964

(22) Filed: Feb. 28, 2017

(30) Foreign Application Priority Data
Mar. 14, 2016 (JP) 2016-049147

(51) Int. Cl. G06F 12/14; G06F 12/0897; G06F 12/1027; G06F 12/0875

(52) U.S. Cl. CPC G06F 12/145; G06F 12/0875; G06F 12/0897; G06F 12/1027; G06F 2212/1008; G06F 2212/152; G06F 2212/452; G06F 2212/604

(57) ABSTRACT

A processing device includes a cache memory to temporarily register data stored in the main memory and a registration circuit that, when registering the data stored in the main memory to the cache memory, acquires identification information set in association with an area in that the data to be registered is stored in the main memory, and registers, in the cache memory, the identification information together with the data to be registered. The processing device further includes a comparison circuit that, when executing an instruction to access the main memory, compares access information specified together with an address of an access destination and identification information registered together with access object data in the cache memory, with each other. The processing device yet further includes an access limitation circuit that stops execution of the instruction to access the main memory in accordance with a result of the comparison.

### CROSS-REFERENCE TO RELATED APPLICATIONS

This application is based upon and claims the benefit of priority of the prior Japanese Patent Application No. 2016-049147, filed on Mar. 14, 2016, the entire contents of which are incorporated herein by reference.

### FIELD

An aspect of the present invention relates to a processing device, an information processing apparatus, and a control method of the processing device.

### BACKGROUND

A processor which is a processing device fetches, decodes, and executes an instruction included in software. Instructions include memory access instructions such as a load instruction and a store instruction which involve accessing a memory. An operating system which controls a processor is capable of reserving a memory area by executing a memory area allocation function in accordance with a request by another program or the like. When executing a memory access instruction with respect to a memory area reserved by a memory area allocation function, the presence of a defect or an incorrect code in a program may cause a processor executing the program to access a memory outside a memory area of a correct address. In addition, the processor may inadvertently rewrite data in a memory area of a correct address with incorrect data. Such bugs and incorrect codes of a program result in memory destruction. Furthermore, a defect may occur when the processor refers to data in a memory outside a memory area of a correct address.

### SUMMARY

One aspect of the technology of the disclosure is exemplified by a processing device to access a main memory. The processing device includes a cache memory configured to temporarily register data stored in the main memory and a registration circuit that, when registering the data stored in the main memory to the cache memory, acquires identification information set in association with an area in that the data to be registered is stored in the main memory, and registers, in the cache memory, the identification information together with the data to be registered. The processing device further includes a comparison circuit that, when executing an instruction to access the main memory, compares access information specified together with an address of an access destination and identification information registered together with access object data in the cache memory, with each other. The processing device yet further includes an access limitation circuit that stops execution of the instruction to access the main memory in accordance with a result of the comparison.

The object and advantage of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a diagram illustrating operations of a user program which requests reservation of a memory area and an operating system;

FIG. 2 is a diagram showing a first example of memory destruction;

FIG. 3 is a diagram showing a second example of memory destruction;

FIG. 4 is a diagram illustrating an information processing apparatus including a processor and a main memory according to Embodiment 1;

FIG. 5 is a configuration diagram illustrating a relationship of hardware related to memory protection according to Embodiment 1;

FIG. 6 is a flow chart illustrating a procedure of memory protection according to Embodiment 1;

FIG. 7 is a flow chart illustrating a memory area allocation process according to Embodiment 1;

FIG. 8 is a diagram illustrating a format of a starting address returned by an OS to a user program in response to a system call by a memory area allocation function;

FIG. 9 is a diagram illustrating allocated areas of a memory and respective management area identification key values and starting addresses;

FIG. 10 shows a format of one entry of a memory key table;

FIG. 11 is a diagram illustrating a configuration of a processor according to Embodiment 1;

FIG. 12 is a diagram showing a configuration of a TLB unit;

FIG. 13 is a diagram illustrating a relationship among an L1 data TAG, an L1 data cache, and a key check unit according to Embodiment 1;

FIG. 14 is a diagram illustrating a format of one entry of a TAG section 18A;

FIG. 15 is a diagram illustrating details of a key table address generation circuit;

FIG. 16 is a detailed view of a key check circuit 153;

FIG. 17 shows an example of an operation truth table of the key check circuit 153;

FIG. 18A is a flow chart showing processes by the processor according to Embodiment 1, and FIG. 18B is a flow chart showing processes by the processor according to Embodiment 1;

FIG. 19 is a diagram illustrating a configuration of a TLB unit 14 according to Embodiment 1;

FIG. 20 is a diagram illustrating a relationship among processes according to Embodiment 2;

FIG. 21 is a diagram illustrating a configuration of a virtual address according to Embodiment 2;

FIG. 22 is a diagram illustrating a configuration of a memory key according to Embodiment 2;

FIG. 23 is a diagram illustrating a format of one entry of a TAG section according to Embodiment 2;

FIG. 24 is a diagram illustrating an operation truth table of a key check circuit according to Embodiment 2;

FIG. 25 is a diagram illustrating configurations of an L1 data TAG, an L1 data cache, and a key check unit according to Embodiment 2;

FIG. 26 is a diagram illustrating a configuration of the key check circuit according to Embodiment 2; and

FIG. 27 is a flow chart illustrating processes of an OS which are executed by an information processing apparatus according to Embodiment 2.

### DESCRIPTION OF EMBODIMENT(S)

Hereinafter, a processing device according to an embodiment will be described with reference to the drawings.

### COMPARATIVE EXAMPLE

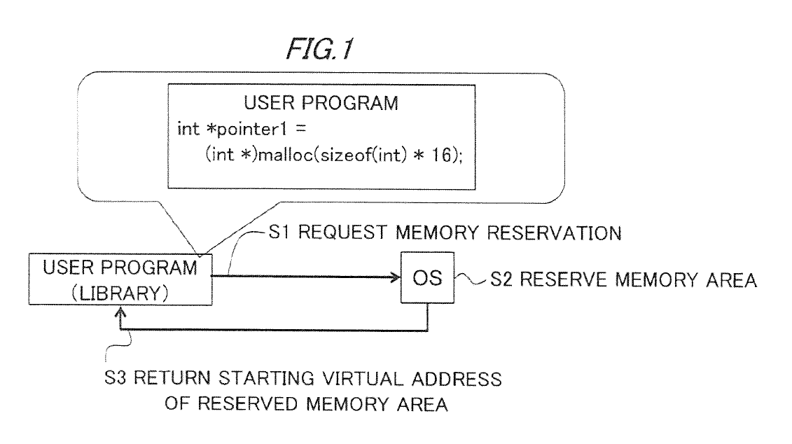

FIG. 1 is a diagram illustrating operations of a user program and an operating system (OS) when reservation of a memory area is requested. The user program requests the OS to reserve (or allocate) a memory area including 16 areas for size “sizeof(int)” using a memory area allocation function malloc (S1). In response thereto, the OS reserves a memory area (S2), and returns a starting virtual address of the reserved memory area as an address pointer pointer1 (S3). Accordingly, a memory area with a position indicated by the address pointer pointer1 as a starting virtual address is allocated in a memory.

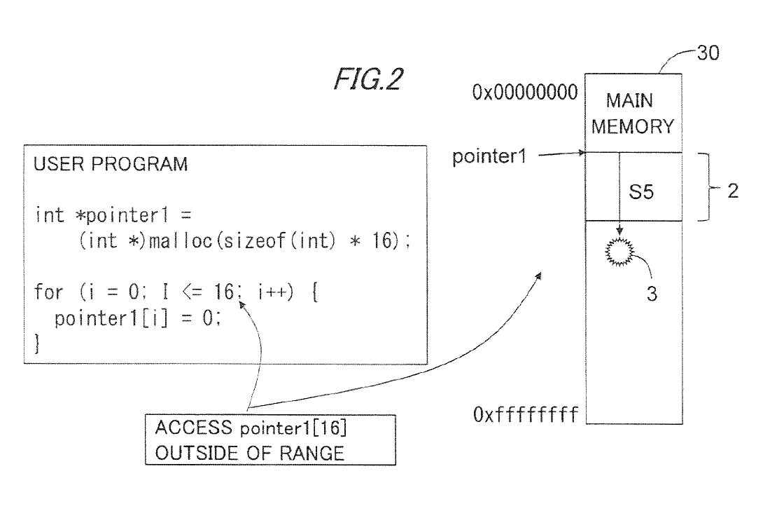

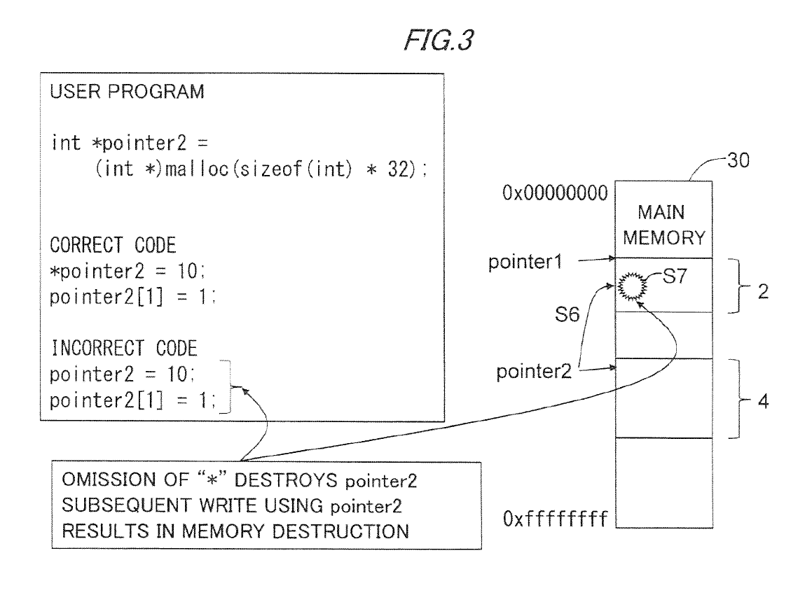

FIG. 2 is a diagram showing a first example of memory destruction. FIG. 2 shows a user program which causes memory destruction and a main memory 30 as a main storage apparatus. The memory area allocation function malloc is also shown in the user program and, due to the area allocation function, a memory area 2 which has the address indicated by the address pointer pointer1 as a starting address and which includes 16 areas for size “sizeof(int)” is allocated in the memory.

In the example shown in FIG. 2, a “for” statement in the user program describes that a numerical value “0” is to be written into memory areas at addresses pointer[i], where i=0 to i=16.

As a result, the processor executing the program inadvertently writes the numerical value “0” to pointer1 [16] which is outside the memory area 2 allocated by the execution of the “for” statement (SS), and ends up destroying data in an area 3.

FIG. 3 is a diagram showing a second example of memory destruction. FIG. 3 shows a user program which causes memory destruction and the main memory 30. The memory area allocation function malloc and a subsequent correct code and an incorrect code are shown in the user program.

### (Correct Code)

*pointer2=10;
pointer2 [1]=1;

### (Incorrect Code)

pointer2=10;
pointer2 [1]=1;

Due to the memory area allocation function malloc, the OS executes a similar operation to that shown in FIG. 1 to reserve a memory area 4 in the memory and return a starting virtual address thereof as an address pointer pointer2. On the other hand, the correct code is an instruction to write a numerical value “10” in a memory area corresponding to an address indicated by the address pointer pointer2 and to write a numerical value “1” in a memory area at an address subsequent to the address indicated by the address pointer pointer2.

In contrast to the correct code, with the incorrect code, the processor writes a numerical value “10” into the address pointer pointer2 and ends up changing the starting virtual address itself having been returned from the OS (S6). In addition, the code pointer2 [1]=1 following the process of S6 causes a numerical value “1” to be written into a memory area 2 which differs from the memory area 4 (S7).

As a result, data of the memory area 2 is destroyed. The destruction of data in a memory is called memory destruction.

In addition to cases where a processor writes data into a memory area as with a store instruction, problems may occur even in cases where the processor reads data from a memory area to a data register or the like as with a load instruction. In other words, reading of data outside an allocated memory area by the processor may result in a bug and can be considered a type of memory destruction.

As a method of detecting the occurrence of memory destruction, for example, a trap may conceivably be generated when executing a load instruction or a store instruction that is a memory access instruction. For example, the processor may execute a program such as a debugger in response to the generated trap. In addition, the processor may check whether or not an address to be accessed by the load instruction or the store instruction is within an address range of a memory area reserved in advance. However, with a check using a debugger or the like, a trap is generated every time a load instruction or a store instruction is executed and significantly increases overhead.

In addition, for example, a method is proposed in which, during memory allocation, a processor registers address range information indicating an address range of an area allocated in a memory in an address range table. This method uses hardware which refers to the address range table in response to an execution of a memory access instruction with respect to a memory allocation area. The hardware performs a determination process as to whether or not an access destination address of the memory access instruction is within a range indicated by address range information registered in the address range table. However, there is a limit to the number of hardware which refers to the address range table at high speed such as the number of registers storing the address range table, and instruction execution performance declines when a load is created which exceeds the limit.

In addition, for example, a spare bank may conceivably be associated with a bank of a memory in which memory allocation is to be executed, in which case a determination on whether or not an access to a memory allocation area is correct may be made using the spare bank. However, this method is based on the premise that a spare bank is prepared and results in increased cost. Furthermore, with this method, an access occurs to both a memory that is accessed in accordance with the execution of a program and to the spare bank, and a bandwidth for communication between the processor and the memory is used accordingly.

Furthermore, recent processors are equipped with a high-hierarchy cache memory. Therefore, for example, a spare bank may conceivably be stored in cache. However, simply storing data in a memory that is accessed in accordance with the execution of a program and data of a spare bank in cache results in a decline in utilization efficiency or a hit rate of the cache. In consideration thereof, in the following embodiments, a processing device will be described in which limitations in the number of dedicated hardware and in memory capacity are less likely to occur, which is capable of suppressing a decline in utilization efficiency of a processor or a cache, and which is capable of detecting unauthorized memory access.

### Embodiment 1

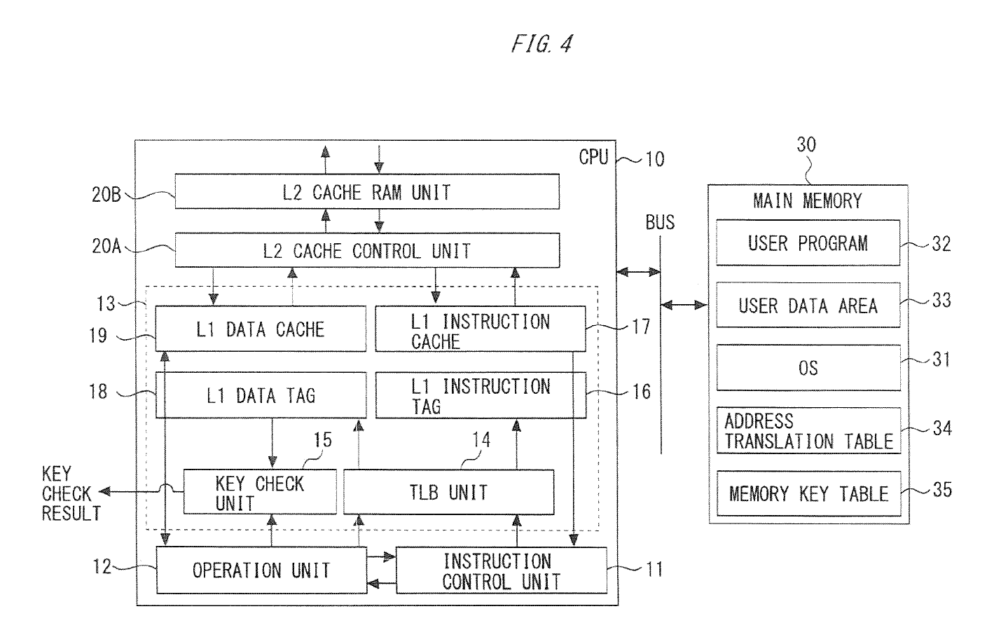

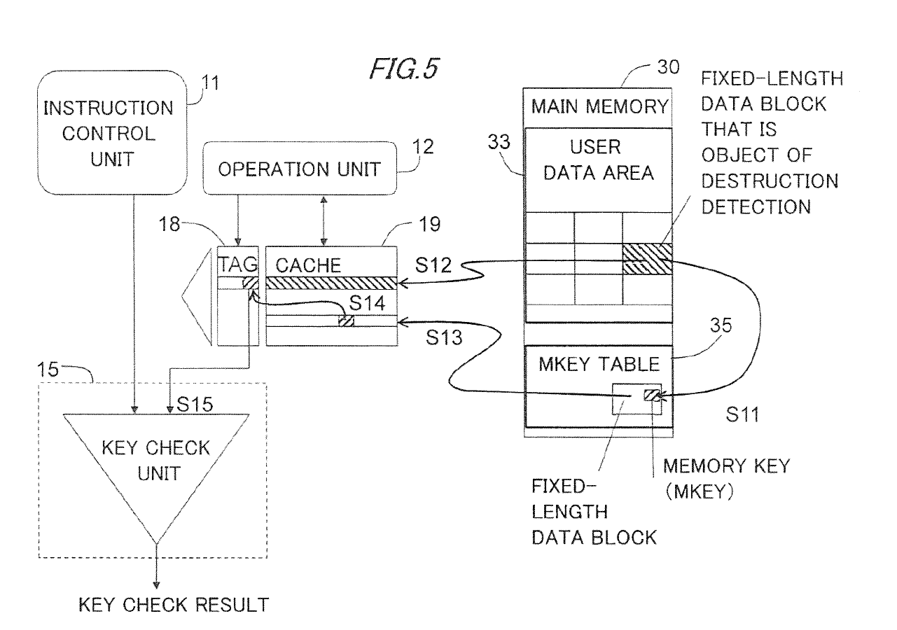

Hereinafter, with reference to diagrams shown in FIGS. 4 to 19, a processing device, an information processing apparatus including the processing device, and a control method of the processing device according to Embodiment 1 will be described. FIG. 4 is a diagram illustrating an information processing apparatus including a CPU 10 as a processing device according to Embodiment 1 and a main memory 30 as a main storage apparatus. In FIG. 4, the central processing unit (CPU) 10 and the main memory 30 are connected to each other via a bus BUS. The CPU 10 is also referred to as a processor. The CPU 10 includes an instruction control unit 11 which performs instruction fetching, decoding, and the like, an operation unit 12 which performs an operation in accordance with a decoding result, a primary (L1) cache control unit 13, a secondary (L2) cache control unit 20A, and a L2 cache RAM unit 20B. The L1 cache control unit 13 includes a translation lookaside buffer (TLB) unit 14 which translates a virtual address of a memory into a physical address, an L1 instruction TAG 16, an L1 instruction cache 17, an L1 data TAG 18, and an L1 data cache 19.

Furthermore, the L1 cache control unit 13 includes a key check unit 15 which determines whether or not an access destination address of a memory access instruction such as a load instruction and a store instruction is accessible. In this case, the access destination address of a memory access instruction is, for example, an address of a memory allocation area having been allocated by a memory area allocation function. In Embodiment 1, when the key check unit 15 determines that the access destination address of a memory access instruction is inaccessible, the CPU 10 determines that an instruction to access the access destination address determined as inaccessible is an instruction that causes memory destruction. The key check unit 15 is an example of “a comparison circuit which, when executing an instruction to access the main memory, compares access information specified together with an address of an access destination and identification information registered together with access object data in the cache memory, with each other”. Hereinafter, a configuration which detects an instruction causing memory destruction as exemplified by the key check unit 15 will be referred to as a key check mechanism. In addition, a process by the key check mechanism will be referred to as a memory destruction detection process.

An OS 31, a user program 32, and a user data area 33 in which a memory area is allocated in accordance with a request from the user program 32 are deployed in the main memory 30. The instruction control unit 11 acquires an instruction sequence of the OS 31 and the user program 32 which have been executably deployed in the main memory 30 via the L1 instruction cache 17, the L2 cache control unit 20A, and the L2 cache RAM unit 20B, and causes the operation unit 12 to execute the instruction sequence. The L1 data TAG 18 and the L1 data cache 19 are examples of a cache memory configured to temporarily register data stored in the main memory. The instruction control unit 11 and the operation unit 12 are examples of an execution unit.

Furthermore, an address translation table 34 and a memory key table 35 are stored in the main memory 30. The address translation table 34 stores a correspondence between a virtual address (VA) specified by an operand of a memory access instruction and a physical address (PA) of the main memory 30. Each entry in the memory key table 35 stores a memory key corresponding to each fixed block in a memory allocation area having been allocated by a memory area allocation function.

In addition, a part of elements in the address translation table 34 are temporarily cashed in a TLB in the TLB unit 14 in the L1 cache control unit 13. In an address translation process, first, a TLB is referenced, and when there is a hit, a translated physical address is output. When there is no hit in the TLB, the address translation table 34 in the main memory 30 is referenced and a virtual address is translated into a physical address.

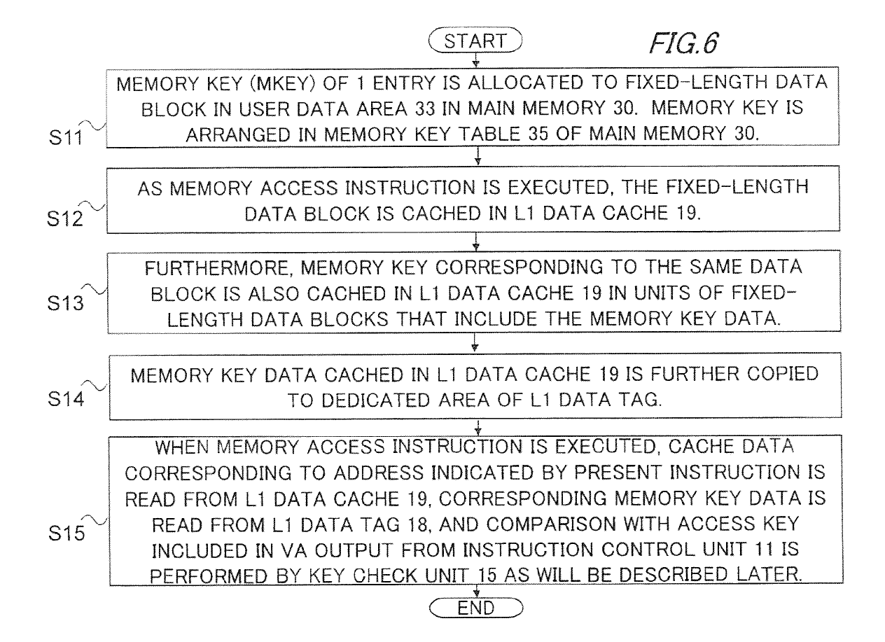

FIG. 5 is a configuration diagram illustrating a relationship of hardware related to memory protection according to Embodiment 1. In addition, FIG. 6 is a flow chart illustrating a procedure of memory protection according to Embodiment 1.

The OS 31 assigns a memory key (MKEY) of one entry to a fixed-length data block in the user data area 33 in the main memory 30. The memory key is arranged in the memory key table 35 in the main memory 30 (S11).

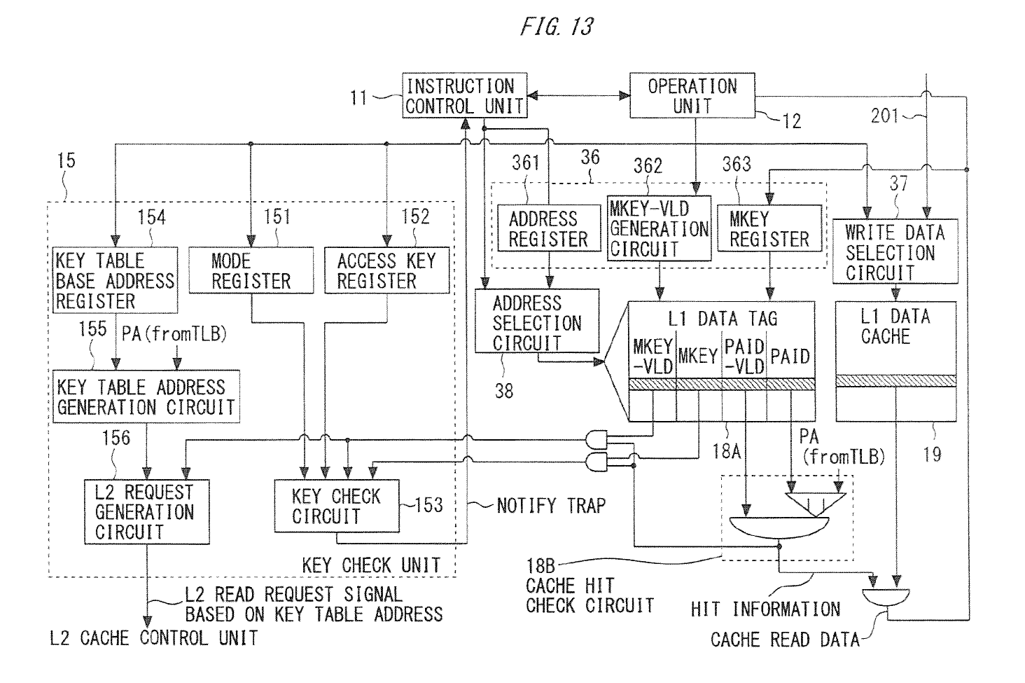

As a memory access instruction is executed, a fixed-length data block in the main memory 30 which corresponds to an address indicated by an operand of the memory access instruction is cached in the L1 data cache 19 (S12). In addition, a memory key corresponding to the cached data block is also cached in the L1 data cache 19 in units of fixed-length data blocks which include data of the memory key (S13). The data of the memory key is called memory key data. A control circuit (an MKEY write control unit 36 shown in FIG. 13) of the L1 data cache 19 further copies the cached memory key data to a dedicated area of the L1 data TAG 18 (S14).

When the memory access instruction is executed, cache data corresponding to an address indicated by an operand of the memory access instruction is read from the L1 data cache 19 and, at the same time, corresponding memory key data is read from the dedicated area of the L1 data TAG 18. At this point, the key check unit 15 compares an access key included in a virtual address VA output from the instruction control unit 11 and the memory key read from the dedicated area of the L1 data TAG 18 with each other (S15). According to the processes described above, a determination is made on whether or not access to an area of the main memory 30 specified by an address indicated in the memory access instruction is permitted.

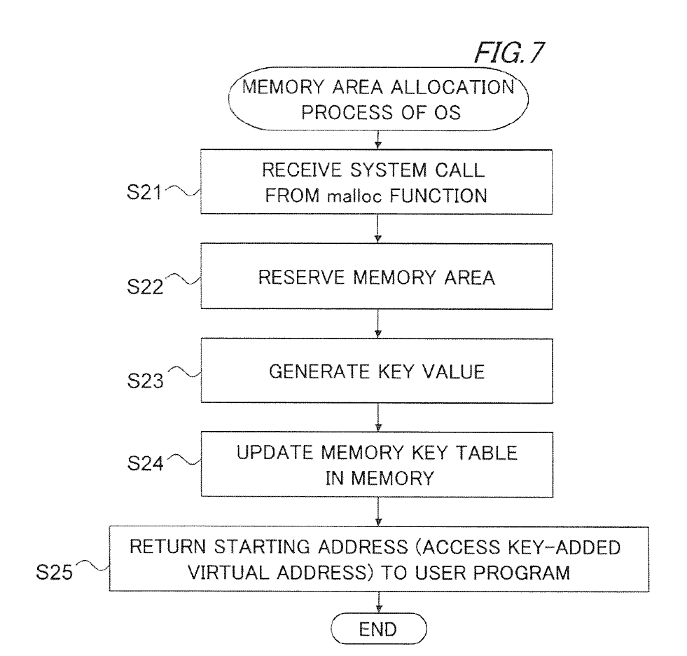

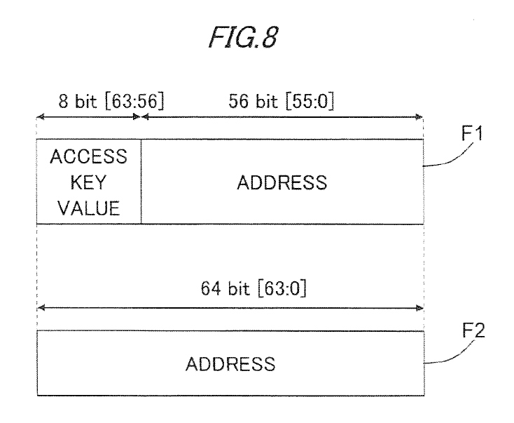

Hereinafter, a memory area allocation process by the OS 31 will be described. FIG. 7 is a flow chart illustrating the memory area allocation process according to Embodiment 1. The CPU 10 executes the OS 31 and the user program 32 which have been executably deployed in the main memory 30, and executes the processes shown in FIG. 7. Hereinafter, in Embodiment 1, an expression of “a (the) program executes . . . ” may be used when the CPU 10 executes a process in accordance with a program. As described with reference to FIG. 1, when the memory area allocation function malloc in the user program 32 is executed, the OS 31 executes a memory area allocation process as follows. As shown in FIG. 7, the OS 31 first receives a system call from the malloc function (S21). In response to the system call, the OS 31 reserves a memory area (hereinafter, a memory allocation area) with a capacity specified by the malloc function in a virtual memory space of the OS 31 which is called a heap area (S22). In addition, the OS 31 generates a management area identification key value which identifies the memory allocation area allocated by the memory area allocation function malloc (S23). The management area identification key value is information for identifying a memory allocation area that is a detection object of memory destruction and is generated by, for example, generating and assigning a random numerical value. However, management area identification key value may be any numerical value as long as duplication can be suppressed to such a degree that a memory area allocated by the memory area allocation function malloc can be identified. For example, the management area identification key value may be a serial number. Note that an ALL0 value (0×00) and an ALL1 value (0×FF) among management area identification key values have a special meaning to the CPU 10 according to Embodiment 1. Therefore, generated management area identification key values are assigned with the exception of the ALL0 value and the ALL1 value.

In addition, the OS 31 stores the management area identification key value of the reserved memory allocation area in the memory key table 35 in the main memory 30 (S24). Subsequently, the OS 31 returns the management area identification key value and a starting address to the user program 32 (S25). The key value handed over to the user program 32 at this point is referred to as an access key. As a result, the user program 32 acquires an access key and a starting address specifying the memory allocation area reserved by a memory allocation request from the user program 32. On the other hand, a management area identification key value stored in the memory key table 35 is referred to as a memory key. The user program 32 executed by the CPU 10 is an example of a first process. The OS 31 executed by the CPU 10 is an example of a second process. The processes of S21 to S24 are an example of “when executing a process of allocating an area on the main memory in accordance with a request from a first process, generates identification information for identifying the area to be allocated and stores the generated identification information in a prescribed area of the main memory”. The process of S25 is an example of “hands over the generated identification information together with an address of the allocated area to the first process as access information that is to be specified when accessing the allocated area”.

FIG. 8 is a diagram illustrating an example of a format of a starting address returned by the OS 31 to the user program 32 in response to a system call by a memory area allocation function. FIG. 8 illustrates an address format F1 in a case where the key check mechanism for detection of memory destruction is enabled and an address format F2 in a case where the key check mechanism is disabled.

When the key check mechanism is enabled, as shown in the address format F1, for example, an access key value is embedded in the most significant 8 bits [63:56] of a 64-bit address [63:0]. In other words, the OS 31 embeds an 8-bit access key value in the most significant 8 bits [63:56] of the starting address [63:0] and returns the access key value to the user program 32.

On the other hand, when the key check mechanism is disabled, as shown in the address format F2, the OS 31 returns a 64-bit starting address in response to the system call by the memory area allocation function. Therefore, the entire 64 bits including the most significant 8 bits constitute address information.

As described above, when the key check mechanism is enabled, by having the OS 31 return an access key value to the user program 32 using a part of bits of a 64-bit starting address, the key check mechanism can be realized while limiting locations of a conventional circuit configuration to be changed. However, since address information in the most significant 8 bits of the starting address is lost, an address range of the memory allocation area is 56 bits [55:0].

Note that the TLB 14 which acts as an address translation unit excludes an 8-bit access key value to be used in key checks in a virtual address from tag comparison objects when performing a hit check of a TLB. The 8-bit access key value is not an address but a value set upon memory allocation by a memory allocation function and therefore needs to be excluded from processing objects of the TLB 14.

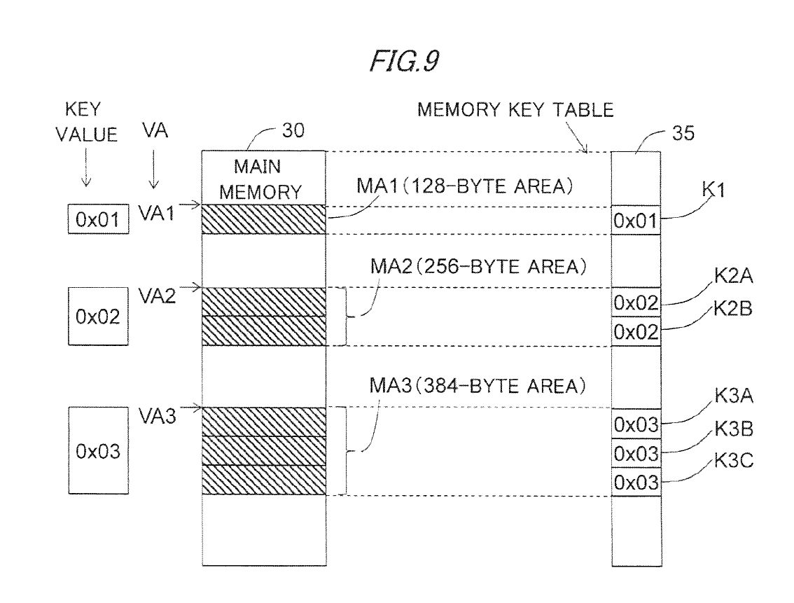

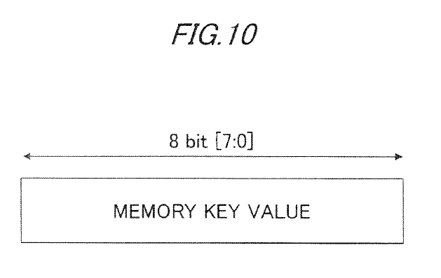

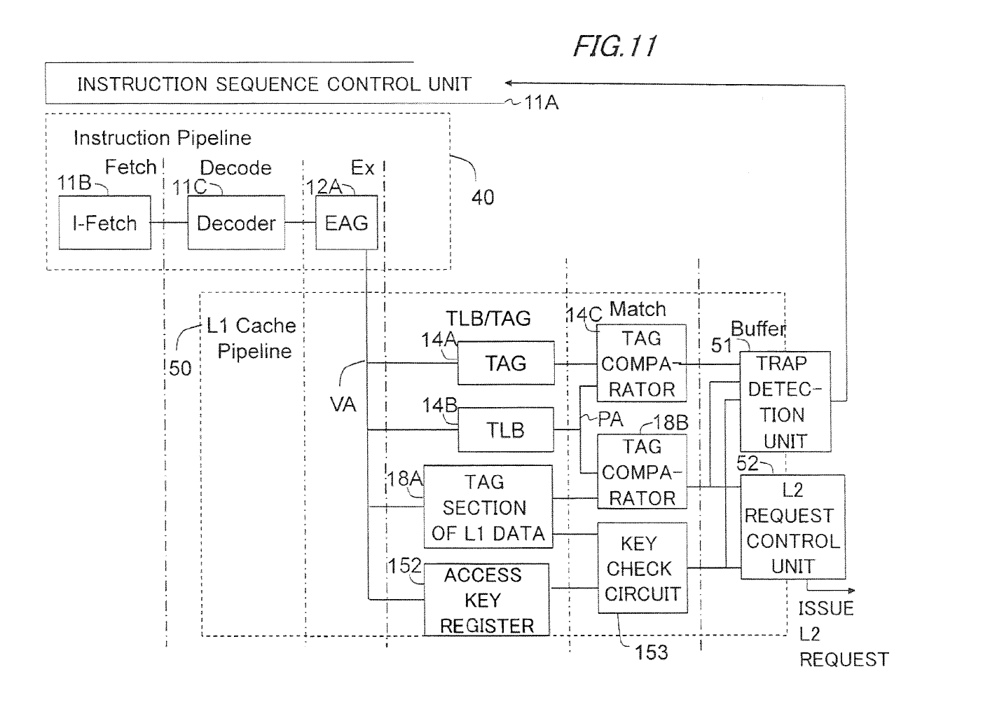

FIG. 9 is a diagram illustrating memory allocation areas of a memory and respective management area identification key values (memory keys) and starting addresses. In addition, FIG. 10 shows a format of one entry of the memory key table 35. In the example shown in FIG. 9, a virtual memory space of the OS 31 corresponding to the main memory 30 such as three memory allocation areas MA1 to MA3 are reserved in, for example, a heap area.

Management area identification key values (for example, 1 to 3) are stored in entries of the memory key table 35 corresponding to the memory allocation areas MA1 to MA3. In addition, the OS 31 returns the management area identification key values 1 to 3 which identify the respective memory allocation areas MA1 to MA3 and starting addresses VA1 to VA3 of the respective memory allocation areas to the user program 32. The memory key table 35 is an example of an element string on the main memory which corresponds to a fixed-length block sequence of the main memory.

Moreover, in Embodiment 1, a minimum unit by which the OS 31 reserves a heap area is 128 bytes which is the same as a cache line size according to Embodiment 1. In this case, a cache line size refers to a fixed block size of data when data of the main memory 30 is registered in a cache memory. Therefore, in Embodiment 1, a boundary of a memory allocation area that is reserved in a heap area aligns with an address boundary that is the same as the cache line size.

Accordingly, in Embodiment 1, when the user program 32 requests an area of 128 bytes or less or an area of which the number of bytes is equal to or larger than 128 bytes and indivisible by 128 with the malloc function, the area to be reserved by the OS 31 is rounded up to units of 128 bytes where an address boundary is aligned.

As described above, in Embodiment 1, while one management area identification key value (memory key) is assigned to each memory allocation area, one entry in the memory key table 35 is assigned for every 128 bytes to memory allocation areas. Therefore, since 384 bytes or, in other words, three 128-byte blocks are allocated in MA3 shown in FIG. 9, three entries (K3A to K3C) are assigned to MA3 in the memory key table. In this case, the same management area identification key value (in FIG. 9, 0×03) is set to all three entries (K3A to K3C).

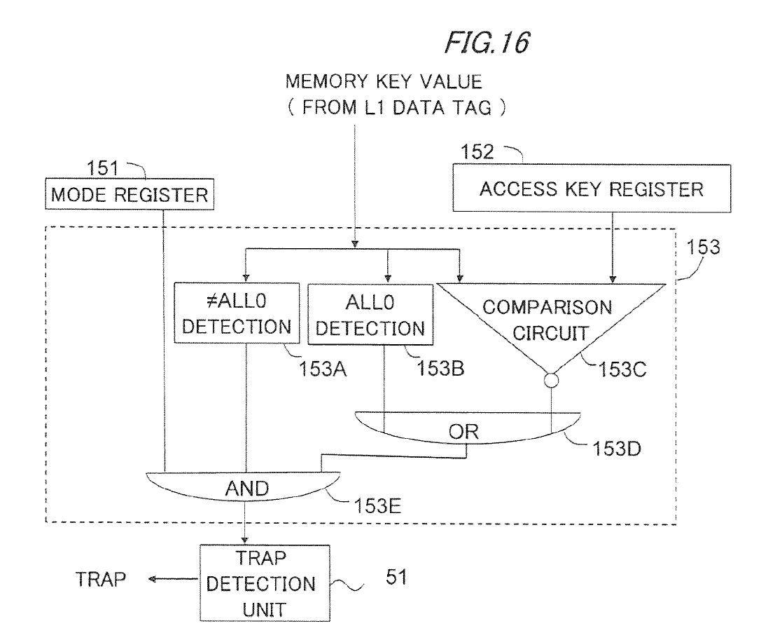

Memory allocation areas reserved by a memory area allocation function include those that are not necessarily an object of a memory destruction detection process. As a management area identification key value for a memory allocation area that is not an object of a memory destruction detection process, the OS 31 may issue a key value ALL0 (a value with 0 as all binary digits: 0×00) which indicates an exemption from memory destruction detection. In addition, when the management area identification key value is ALL0, the OS 31 sets a memory key value in the memory key table 35 corresponding to the memory allocation area to 0×00. An operation of the key check unit 15 when the memory key value is 0×00 will be explained in detail later in the description of FIG. 16.

Furthermore, access to a memory area not reserved by the memory area allocation function in the user data area 33 from all user programs 32 is forbidden. In such a case, the OS 31 may issue a key value ALL1 (a value with 1 as all binary digits: 0×FF) which indicates an exemption from memory access as a management area identification key value. In addition, when the management area identification key value is ALL1, the OS 31 sets a memory key value in the memory key table 35 corresponding to the memory allocation area to 0×FF. An operation of the key check unit 15 when the key value is 0×FF will be explained in detail later in the description of FIG. 16.

FIG. 11 is a diagram illustrating a configuration of the CPU 10 according to Embodiment 1. Hereinafter, a description will be given with reference also to the configuration diagram shown in FIG. 4. FIG. 11 illustrates a configuration of a part of the CPU 10 including an instruction sequence control unit 11A which controls execution completion, an execution order, and the like of instructions, an instruction pipeline 40, and a primary cache pipeline 50. In the drawing, vertical dot chain lines depict boundaries of pipeline stages. The instruction sequence control unit 11A and the instruction pipeline 40 (and the operation unit 12 shown in FIG. 4) execute a system program such as the OS 31 or the user program 32 which include an instruction sequence stored in the main memory 30.

The instruction pipeline 40 includes an instruction fetch circuit 11B which acquires an instruction from the L1 instruction cache 17, a decoder 11C which decodes an instruction, and an effective address generator (EAG) 12A. The instruction sequence control unit 11A, the instruction fetch circuit 11B, and the decoder 11C correspond to a configuration of a part of the instruction control unit 11 shown in FIG. 4. In addition, the effective address generator 12A corresponds to a configuration of a part of the operation unit 12 shown in FIG. 4.

On the other hand, the primary cache pipeline 50 corresponds to a configuration of a part of the L1 cache control unit 13 shown in FIG. 4. The primary cache pipeline 50 executes address translation from a virtual address VA generated by the effective address generator 12A to a physical address. The address translation is executed by a TAG section 14A and a data section 14B of a tagged TLB, and a TAG comparator 14C which detects matching tag values shown in FIG. 11. The TAG section 14A and the data section 14B of the tagged TLB and the TAG comparator 14C correspond to the TLB unit 14 shown in FIG. 4.

The TLB unit 14 translates a virtual address generated by the effective address generator 12A into a physical address. When the tag results in a hit, the TAG comparator 14C validates an output of a physical address PA from the data section 14B. On the other hand, when the tag does not result in a hit, the TAG comparator 14C outputs a tag mishit to a trap detection unit 51. In the example shown in FIG. 11, the TLB unit 14 is controlled by two pipeline stages. In the pipeline processing shown in FIG. 11, retrieval of a tag value by the TAG section 14A of the tagged TLB and retrieval of the physical address PA by the data section 14B of the tagged TLB are executed in parallel. In addition, unless a tag mishit is output to the trap detection unit 51 as a result of a comparison by the TAG comparator 14C, the physical address PA output from the data section 14B is to be used without modification in subsequent processes.

Furthermore, the primary cache pipeline 50 detects that memory data indicated by the physical address PA translated from the virtual address VA generated by the effective address generator 12A is registered in the primary cache. To this end, the primary cache pipeline 50 includes a TAG section 18A of the L1 data TAG 18 and a TAG comparator 18B which detects matching tag values. The TAG section 18A of the L1 data TAG 18 will be simply referred to as the TAG section 18A. The TAG section 18A and the TAG comparator 18B correspond to the L1 data TAG 18 shown in FIG. 4. Accordingly, the TAG section 18A corresponds to a storage section which stores a TAG of the L1 data TAG 18 shown in FIG. 4. A control circuit of the TAG section 18A uses a part of the virtual address VA (a low-order address common to a low-order address of the physical address PA) to identify a set of the TAG section 18A and retrieves a tag in the set (a high-order address of the physical address PA). Subsequently, the TAG section 18A combines the retrieved high-order address of the physical address PA with the low-order address and outputs the combined address to the TAG comparator 18B.

The TAG comparator 18B instructs a cache data response in the case of a cache hit and instructs an L2 request control unit 52 to issue an L2 request when there is no cache hit. As illustrated in FIG. 4, a cache data response is a control signal output from the L1 data TAG 18 to the L1 data cache 19. In addition, in the example shown in FIG. 11, the L1 data TAG 18 is controlled by two pipeline stages. In the pipeline of the L1 data TAG 18, retrieval of a TAG of the physical address PA by the TAG section 18A is executed in parallel with the execution of retrieval of a TAG of the virtual address VA by the TAG section 14A of the tagged TLB and retrieval of the physical address PA by the data section 14B of the tagged TLB. Furthermore, unless an L2 request is issued from the TAG comparator 18B, the physical address output from the TAG section 18A is to be used in subsequent processes and a cache data response is output to the L1 data cache 19.

The primary cache pipeline 50 includes an access key register 152 and a key check circuit 153 for determining whether or not memory data read from the L1 data cache 19 shown in FIG. 4 is accessible. The access key register 152 stores an access key included in a virtual address generated by the effective address generator 12A and outputs the access key to the key check circuit 153. The key check circuit 153 compares the access key output from the access key register 152 with the memory key output from the TAG section 18A to determine whether access is permitted or not, and notifies the trap detection unit 51 and the L2 request control unit 52 whether access is permitted or not.

When the trap detection unit 51 receives any of a tag mishit from the TAG comparator 14C, a cache mishit from the TAG comparator 18B, and an access non-permission signal from the key check unit 15B, the trap detection unit 51 appropriately outputs a corresponding trap/re-execution notification to the instruction sequence control unit 11A. The trap detection unit 51 can also be referred to as a trap detection/re-execution detector. In response to the trap/re-execution notification, the instruction sequence control unit 11A either re-executes an instruction or calls a trap handler of the OS 31 and causes the trap handler to execute respectively corresponding processes. The trap detection unit 51 is an example of an access limitation circuit which stops execution of an instruction to access the main memory in accordance with a result of the comparison.

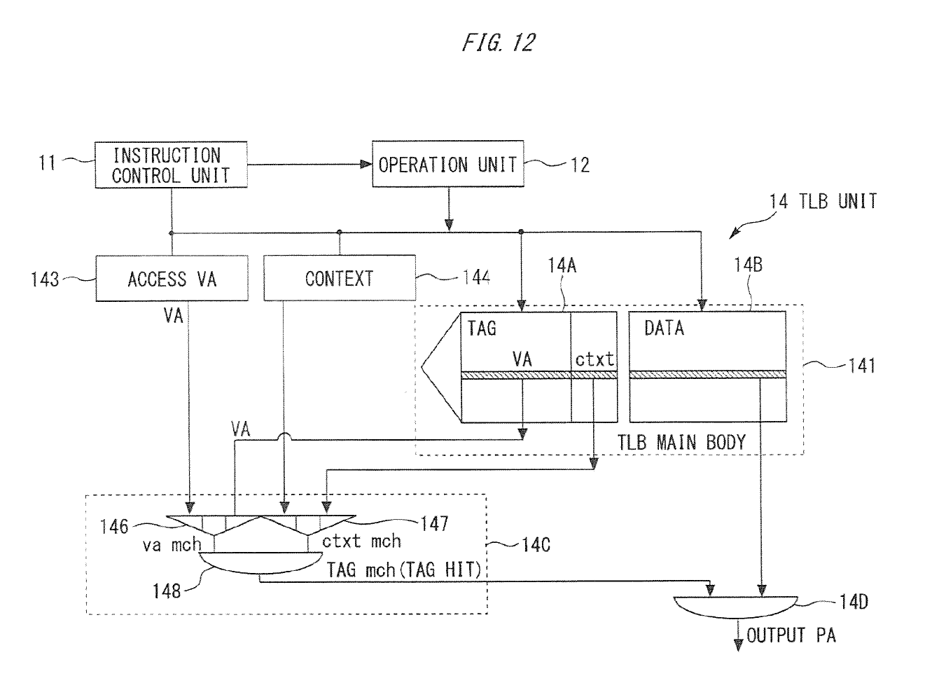

FIG. 12 is a diagram showing a configuration of the TLB unit 14. The TLB unit 14 includes a table look a side buffer (TLB) main body 141 having the TAG section 14A and the data section 14B of a TLB, and the TAG comparator 14C. A virtual address VA of an access destination of a memory access instruction is loaded to an access address register 143 and TLB attribute data is loaded to a context register 144 from the instruction control unit 11 or the operation unit 12. In this case, attribute data refers to, for example, information which identifies a context used when the OS 31 switches processes.

On the other hand, the TAG section 14A of the TLB unit 14 stores a virtual address VA and a context ctxt which is attribute data of the TLB, and the data section 14B of the TLB unit 14 stores a physical address PA which corresponds to the virtual address VA. Therefore, a physical address in the data section 14B corresponding to the virtual address VA in the TAG section 14A which matches the virtual address VA that is the access destination of the memory access instruction is output as a translated address. A comparison process by the TLB unit 14 is as follows.

The TAG comparator 14C compares a set of attribute data corresponding to a memory access instruction loaded to the access address register 143 and the context register 144 with a set of the virtual address VA and the context ctxt stored in the TAG section 14A. The TAG comparator 14C includes a comparator 146, a comparator 147, and an AND gate 148 which performs an AND operation of outputs from the two comparators 146 and 147. The comparator 146 compares the virtual address VA of the access destination in the access address register 143 with a virtual address in the TAG section 14A and, in the case of a match, outputs a virtual address match output va_mch. The comparator 147 compares attribute data in the context register 144 with the context ctxt in the TAG section 14A and, in the case of a match, outputs a context match output ctxt_mch. Searches in the TAG section 14A are sequentially performed, and the physical address PA of the data section 14B upon detecting that both comparators 146 and 147 match is output via the AND gate 14D as the physical address PA after address translation.

When a tag in the TAG section 14A of the TLB unit 14 does not result in a hit, the instruction control unit 11 fetches an entry from the address translation table 34 in the main memory 30 and registers the entry in the TLB main body 141. In other words, when updating an element of the TLB main body 141, the instruction control unit 11 outputs a TLB registration request and update data (VA and PA) of a TLB entry to the TLB unit 14. Accordingly, elements of the TAG section 14A and the data section 14B of the TLB unit 14 are updated, the primary cache pipeline 50 is once again executed, and a search in the TLB unit 14 is once again performed.

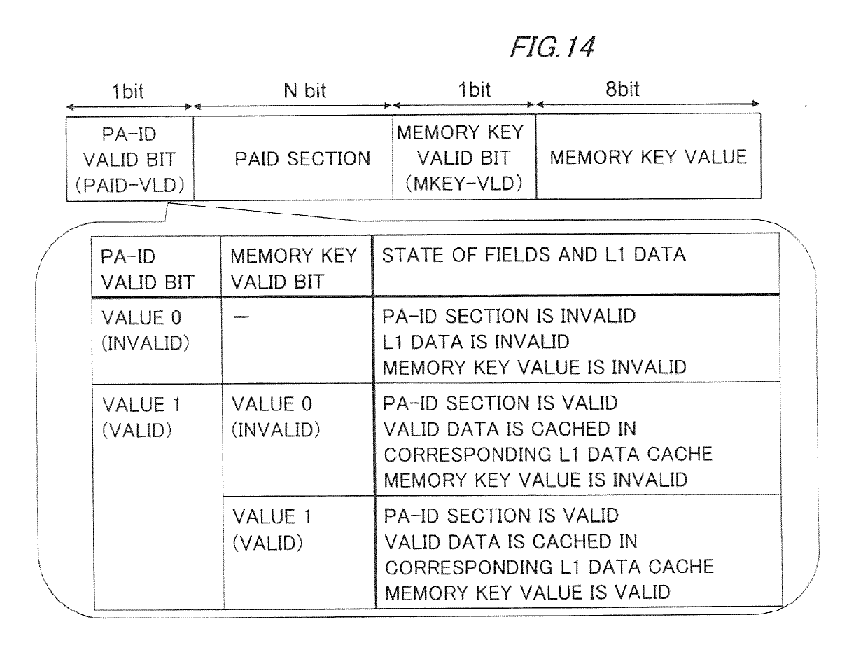

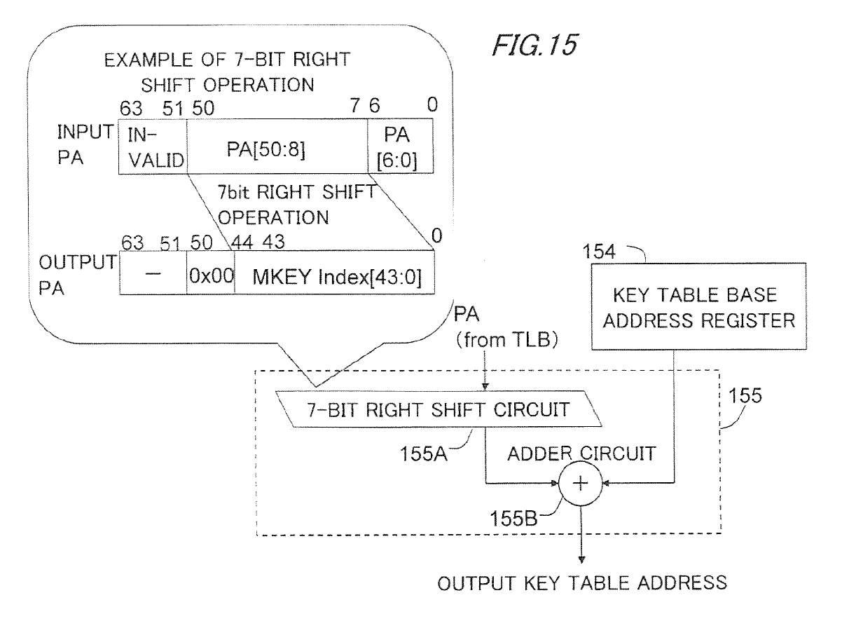

FIG. 13 is a diagram illustrating a relationship among the L1 data TAG 18, the L1 data cache 19, and the key check unit 15 according to Embodiment 1. In addition, FIG. 14 is a diagram illustrating a format of one entry of the TAG section 18A of the L1 data TAG 18. The L1 data TAG 18 includes the TAG section 18A which stores TAG information and the TAG comparator 18B which uses PA information (for example, high-order bits of a physical address PA) read from the TAG section 18A to inspect a hit in the L1 data cache 19. When a virtual address VA results in a hit in the TLB 14 shown in FIG. 4 and the virtual address VA is translated into a physical address PA, the L1 data TAG 18 inspects whether or not memory data indicated by the physical address PA is registered in the L1 data cache 19. As shown in FIG. 14, the TAG section 18A of the L1 data TAG 18 stores a PAID valid bit (PAID-VLD), a PAID section, a memory key valid bit (MKEY-VLD), and a memory key value.

As described with reference to FIG. 11, when a memory access instruction such as a load instruction or a store instruction is executed by the instruction control unit 11, the TAG section 18A is accessed in parallel with an address translation operation by the TLB unit 14. At this point, a virtual address (low-order bits) from the instruction control unit 11 is output to an address selection circuit 38, the address selection circuit 38 uses the virtual address from the instruction control unit 11 to select entries of the TAG section 18A and the L1 data cache 19, and the TAG section 18A and the L1 data cache 19 are simultaneously accessed. When a value of PAID-VLD output from the TAG section 18A is 1, PA output from the TLB and PAID output from the TAG section 18A are compared with each other by the TAG comparator 18B. Since a comparison result of a match signifies a L1 data cache hit, cache data read from the L1 data cache 19 is sent to the operation unit 12 as a response.

The key check unit 15 operates in parallel with the TAG section 18A. A mode register 151 includes, for example, 1 bit. When the mode register 151 indicates valid (bit=1), an operation of the key check circuit 153 is enabled, and when the mode register 151 indicates invalid (bit=0), an operation of the key check circuit 153 is disabled. The access key register 152 is a register which stores an access key used upon memory access. An access key value (refer to FIG. 8) in the virtual address VA of an access destination is loaded to the access key register 152 from the operation unit 12.

The key check circuit 153 receives a value (valid or invalid) of the mode register 151, an access key value of the access key register 152, and a memory key value output from the TAG section 18A upon a cache hit, and inspects whether or not a memory access being executed is permitted. An access key generated by the effective address generator 12A of the operation unit 12 has been loaded to the access key register 152. The L1 data TAG 18 searches in the TAG section 18A based on the virtual address VA from the effective address generator 12A and the physical address PA from the TLB unit 14 and, when the physical address PA results in a hit, outputs a memory key value. The key check unit 15 compares an access key valued loaded to the access key register 152 and a memory key value at the time of hit of the L1 data TAG 18 with each other, and executes processing as a key check mechanism. An operation of the key check circuit 153 will be described later with reference to FIG. 16.

A key table base address register 154 is an address register which stores a starting address of the memory key table 35. A value is loaded in advance from the operation unit 12 to the key table base address register 154 before execution of an instruction. A key table address generation circuit 155 generates a key table address based on the key table base address register 154 and a physical address PA output from the TLB unit 14. An operation of the key table address generation circuit 155 will be described in detail later with reference to FIG. 15. The key table base address register 154 is an example of an address register which specifies a starting address of the element string described earlier in the main memory.

In addition, when the mode register 151 indicates that the key check mechanism is enabled and the memory key valid bit (MKEY-VLD) is invalid, an L2 request generation circuit 156 issues an L2 request to the L2 cache control unit 20A in order to acquire a memory key. Note that, while omitted in FIG. 13, when the mode register 151 indicates that key check is enabled and the memory key valid bit (MKEY-VLD) is invalid, first, a determination is made on whether or not a memory key is cached in the L1 data cache 19 before issuing an L2 request for acquiring a memory key. Furthermore, when a memory key is not cached, the L2 request generation circuit 156 issues an L2 request to the L2 cache control unit 20A.

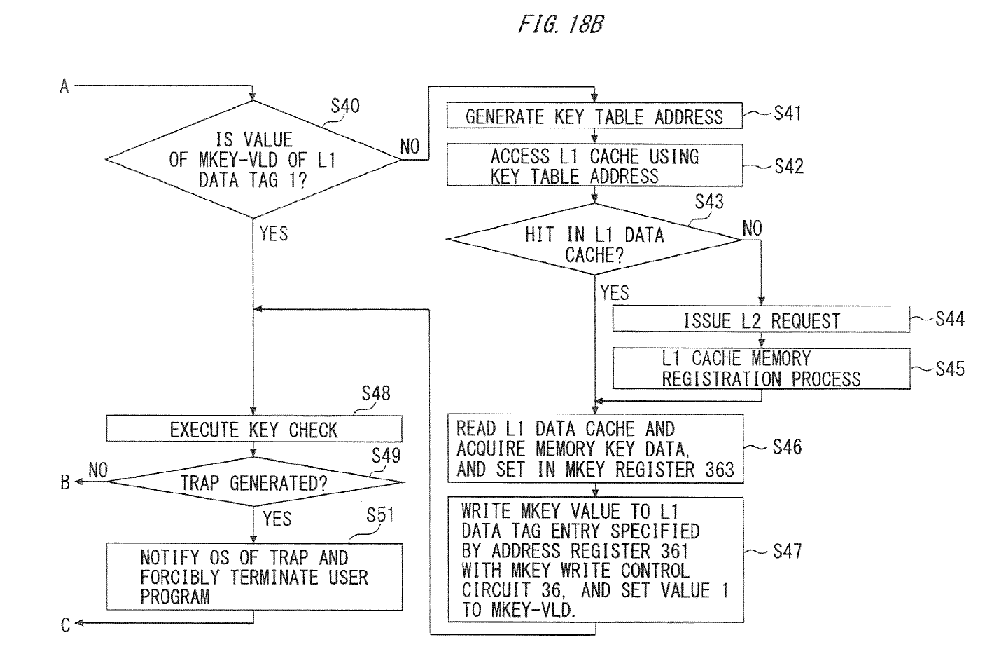

In response to the request, the L2 cache control unit 20A reads data from the L2 cache RAM unit 20B and sends cache data to the L1 data cache 19 as a response with an L2 data response signal 201. The responded cache data is selected by a write data selection circuit 37 and written into the L1 data cache 19. Note that operations for issuing an L2 request signal, responding with the L2 data response signal 201, and writing data into the L1 data cache by the write data selection circuit 37 are similar to operations in a normal L1 cache memory registration process (refer to S37 in FIG. 18A and S45 in FIG. 18B).

The MKEY write control unit 36 is a circuit which controls writing to an MKEY-VLD field and an MKEY field of the TAG section 18A. The MKEY write control unit 36 includes an address register 361, an MKEY-VLD generation circuit 362, and an MKEY register 363. The MKEY write control unit 36 and the write data selection circuit 37 are examples of a registration circuit which, when registering data stored in the main memory to the cache memory, acquires identification information set in association with an area in which the data to be registered is stored in the main memory and registers the identification information together with the data to be registered to the cache memory. The TAG section 18A is an example of a tag section which stores tag information for reading the access object data in the cache memory.

Upon registration of data to the L1 data cache 19 (timing of S37 and S38 in FIG. 18A), a value 0 is generated and written into the MKEY-VLD field by the MKEY-VLD generation circuit 362. At this point, an address used when the MKEY-VLD generation circuit 362 had accessed the L1 data TAG is stored in the address register 361. Accordingly, processing in the event of a mishit of the L1 data cache 19 is completed and the interrupted pipeline is re-executed.

Subsequently, after re-execution of the pipeline, when the MKEY-VLD is 0 (invalid) and MKEY data is cached in the L1 data cache when MKEY-VLD is next referenced (timing of S46 in FIG. 18B), the MKEY data read from the L1 data cache is set to the MKEY register 363.

In addition, at a timing of S47 in FIG. 18B, the address stored in the address register 361 is selected by the address selection circuit 38. Subsequently, with respect to an entry of the TAG section 18A specified by the selected address, a value 1 is generated by the MKEY-VLD generation circuit 362 and written to the MKEY-VLD field. Furthermore, with respect to the specified entry of the TAG section 18A, the MKEY data set to the MKEY register 363 is written to the MKEY field.

As shown in FIG. 14, one entry of the TAG section 18A includes a PAID valid bit (PAID-VLD), a PAID section, a memory key valid bit (MKEY-VLD), and a memory key value. When the value of the PAID valid bit is 0 (invalid), the PAID section is invalid, L1 data is invalid, and the memory key value is also invalid. When the value of the PAID valid bit is 1 (valid) and the value of the memory key valid bit is 0 (invalid), the PAID section is valid but the memory key value is invalid despite valid data being cached in the L1 data cache 19 corresponding to the PAID section or, in other words, the TAG. On the other hand, when the value of the memory key valid bit is 1 (valid), the memory key value is also valid.

FIG. 15 illustrates details of the key table address generation circuit 155. The key table address generation circuit 155 first generates an index address of a memory key from a physical address PA. As already described with reference to FIG. 9, when a minimum unit by which a memory area is reserved is set to, for example, 128 bytes, an index address of a memory key is obtained by shifting valid bits of the physical address PA by 7 bits with a 7-bit right shift circuit 155A. Next, by adding up the index address of the memory key and a value of the key table base address register 154 with an adder circuit 155B, a target memory key address (a key table address) is obtained.

In this case, the key table base address register 154 is set by the OS 31.

When the OS 31 allocates the memory key table 35 on the main memory 30, a starting address of the memory key table 35 may be set to the key table base address register 154.

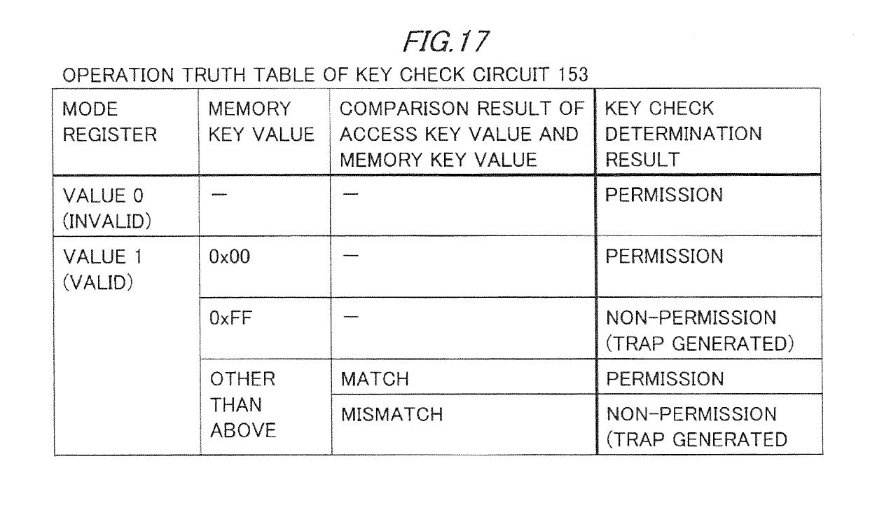

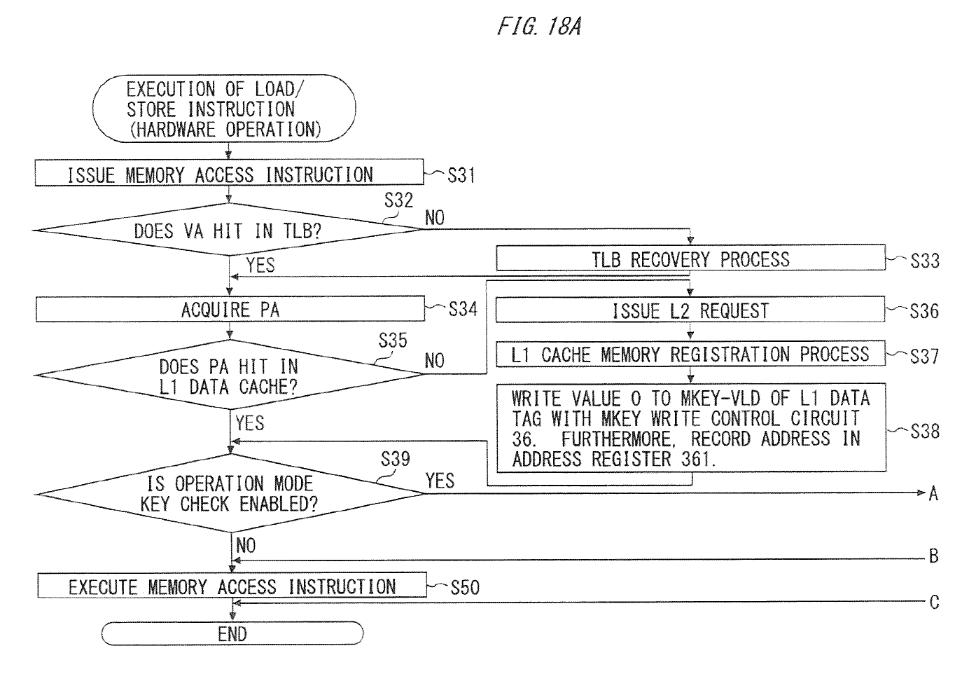

FIG. 16 is a detailed view of the key check circuit 153, and FIG. 17 shows an example of an operation truth table of the key check circuit 153. The key check circuit 153 compares a memory key value and an access key value with each other in the key check unit 15. As described earlier, the memory key value is read from the TAG section 18A. In addition, the access key value is acquired from the virtual address VA of a memory access instruction executed by the user program 32. As illustrated in FIG. 13, the access key value is set to the access key register 152 by the operation unit 12. In addition, the mode register 151 indicates a value 1 (valid, true) when the key check mechanism is enabled. Therefore, when the memory key value and the access key value do not match each other, output of a comparison circuit 153C is inverted and a trap request is issued to the trap detection unit 51 by an OR gate 153D and an AND gate 153E. When receiving the request to generate a trap, the trap detection unit 51 notifies the OS 31 of a trap via the instruction sequence control unit 11A (refer to FIG. 11).

On the other hand, when the memory key value and the access key value match each other, a trap request is not issued and memory access is permitted. In addition, when the memory key value is ALL1 (0×FF), a trap request is issued by the OR gate 153D and the AND gate 153E regardless of the comparison result of the comparison circuit 153C. Furthermore, when the memory key value is ALL0 (0×00), a trap request is suppressed and memory access is permitted regardless of the comparison result of the comparison circuit 153C.

FIGS. 18A and 18B are flow charts showing processes by the CPU 10 including the TLB unit 14, the L1 data TAG 18, the L1 data cache 19, and the key check unit 15. While the TLB unit 14, the L1 data TAG 18, the L1 data cache 19, and the key check unit 15 are hardware circuits, an operation sequence thereof will be described with reference to the flow charts. In addition, since the TLB unit 14, the L1 data TAG 18, the L1 data cache 19, and the key check unit 15 are controlled within the primary cache pipeline 50 (refer to FIG. 11), the respective processes in the flow charts shown in FIGS. 18A and 18B are repetitively executed by re-execution operations of the pipeline.

As a result of decoding by the decoder 11C, a memory access instruction is issued (S31). Consequently, first, the TLB unit 14 determines whether or not a virtual address VA has resulted in a hit in the TAG section 14A of the TLB unit 14 (S32). When the virtual address VA does not result in a hit in the TAG section 14A of the TLB unit 14, the instruction control unit 11 fetches an entry from the address translation table 34 in the main memory 30 and registers the entry in the TLB (S33). The process of S33 is also called a TLB recovery process. At this timing, the primary cache pipeline 50 is interrupted and a pipeline process is re-executed after the TLB recovery process. When the virtual address VA results in a hit in the TAG section 14A of the TLB unit 14 in the determination of a next S32, in the TLB unit 14, a search is performed by the TAG section 14A and a physical address PA is acquired from the data section 14B (S34).

Next, the L1 data TAG 18 determines whether or not the physical address has resulted in a hit in the L1 data cache 19 (the TAG section 18A) (S35). When the physical address does not result in a hit in the L1 data cache 19, an L2 request is issued from the L2 request control unit 52 (S36). In response to the request, the L2 cache control unit 20A reads data from the L2 cache RAM unit 20B and sends cache data to the L1 data cache 19 as a response. Consequently, the control circuit of the L1 data TAG 18 and the control circuit of the L1 data cache 19 register the responded data and the TAG in the L1 data cache 19 and the L1 data TAG 18 (S37). At this point, the MKEY write control unit 36 writes a value 0 in MKEY-VLD of the TAG section 18A of the L1 data TAG 18 (S38). In addition, an address of an entry of the TAG section 18A having the value 0 written in MKEY-VLD is stored in the address register 361 of the MKEY write control unit 36. Accordingly, processing in the event of a mishit of the L1 data cache 19 is completed and the interrupted primary cache pipeline 50 is re-executed. Furthermore, in a next pipeline process, the determination of S35 is made once again.

In the event that the physical address results in a hit in the L1 data cache in the determination of S35, when the mode register 151 indicates that the key check mechanism is enabled (YES in S39) and, at the same time, the value of MKEY-VLD of the TAG section 18A is not 1 (valid) (NO in S40), the key table address generation circuit 155 generates a key table address (S41). In addition, in order to acquire a memory key, the MKEY write control unit 36 accesses the L1 data cache using the key table address (S42). Furthermore, when the key table address does not result in a hit in the L1 data cache (NO in S43), the L2 request generation circuit 156 issues an L2 request to the L2 cache control unit 20A (S44). In response to the request, the L2 cache control unit 20A reads data from the L2 cache RAM unit 20B and sends cache data to the L1 data cache 19 as a response through the L2 data response signal 201. The responded data is selected by the write data selection circuit 37 and written into the L1 data cache 19 (S45). Accordingly, processing in the event of a mishit of the L1 data cache 19 is completed and the interrupted primary cache pipeline 50 is re-executed. Furthermore, in a next pipeline process, the determination of S43 is made once again.

When the key table address results in a hit in the L1 data cache in the determination of S43, the MKEY write control unit 36 reads a memory key value in cache data and set in the MKEY register 363 (S46). Next, the MKEY write control unit 36 writes the memory key value of the MKEY register 363 to an entry of the tag section 18a of L1 DATA TAG 18, specified by the address register 361. Then, the MKEY write control unit 36 sets a value 1 to MKEY-VLD of the TAG section 18A (S47). Accordingly, processing in the event that the value of MKEY-VLD of the TAG section 18A is not 1 (valid) is completed and the interrupted primary cache pipeline 50 is re-executed. Furthermore, in a next pipeline process, the determination of S40 is made once again.

When the value of MKEY-VLD of the TAG section 18A is 1 (valid) in the determination of S40, the key check circuit 153 executes a key check (S48). As a result of the key check in S48, when a trap is not generated, control returns to S50 and the memory access instruction is executed. On the other hand, when a trap is generated in S49, the trap detection unit 51 notifies the OS 31 of a trap via the instruction sequence control unit 11A (refer to FIG. 11). As a result, the user program 32 is forcibly terminated.

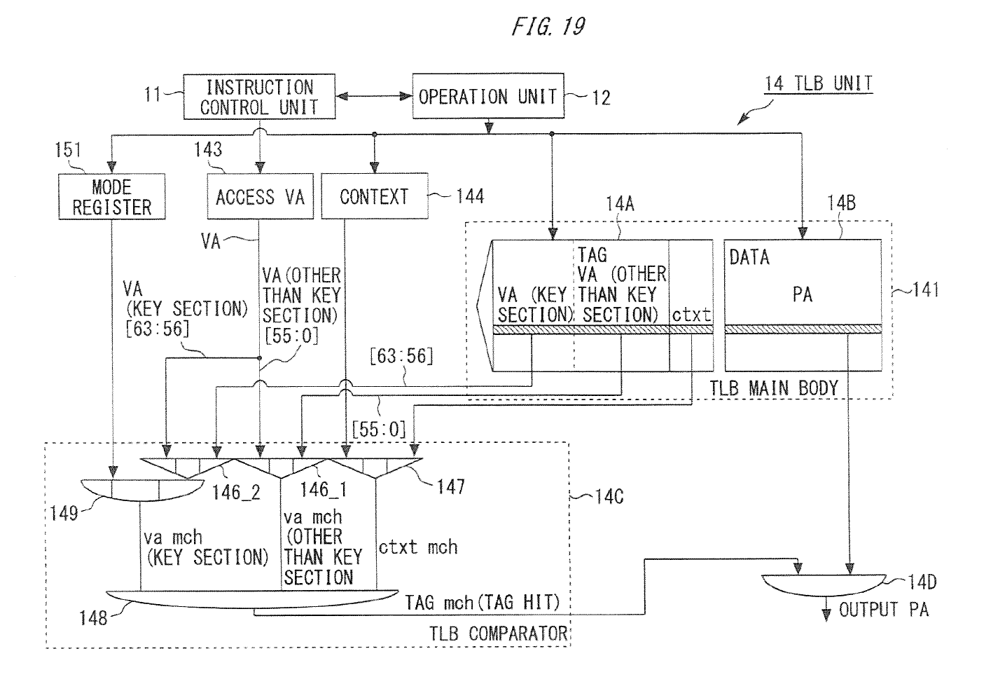

FIG. 19 is a diagram illustrating a configuration of the TLB unit 14 according to Embodiment 1. As already described with reference to FIG. 8, in Embodiment 1, when the key check mechanism is set to enabled, the OS 31 embeds a management area identification key in the most significant 8 bits [63:56] of the virtual address VA [63:0] and identifies a plurality of memory allocation areas as management target areas of a key check. On the other hand, when the key check mechanism is set to disabled, the OS 31 does not embed a management area identification key [63:56] in the virtual address VA [63:0]. In this manner, with the information processing apparatus according to Embodiment 1, the 64 bits [63:0] of an existing virtual address VA are effectively utilized and a circuit change for performing a key check is avoided to the greatest extent feasible.

As a result, when the value of the mode register 151 is 1, a virtual address format returned by the OS 31 in response to a system call by a memory area allocation function is key value [63:56], VA [55:0], and the virtual address (key [63:56], VA [55:0]) is stored in the TAG section 14A of the TLB unit 14. On the other hand, there may be cases where a virtual address that is an object of address translation is an address outside a memory area allocated by the memory area allocation function. Therefore, an address indicated by key [63:56], VA [55:0] and an address indicated by VA [63:0] are to coexist in the TAG section 14A of the TLB unit 14. In consideration thereof, the TLB unit 14 according to Embodiment 1 is configured so as to ignore a matching result of key [63:56] when the value of the mode register 151 is 1. This is adopted in order to avoid a malfunction of the TLB unit 14 due to key [63:56], which is information that is not a virtual address, being embedded in a portion of a virtual address field.

Specifically, in the TLB unit 14, information of the most significant 8 bits [63:56] in the 64-bit virtual address VA differs between a case where the key check mechanism is enabled (the value of the mode register 151 is 1) and a case where the key check mechanism is disabled (the value of the mode register 151 is 0).

In consideration thereof, in Embodiment 1, the TLB unit 14 executes different control depending on whether or not the key check mechanism is enabled. Specifically, when the key check mechanism is enabled (mode=1), the most significant 8 bits [63:56] of the virtual address VA is valid as a key and cannot be regarded as a part of the virtual address VA. In this case, a comparison result of the most significant 8 bits is ignored in the TLB determination by the TLB unit 14. When the key check mechanism is disabled (mode=0), the most significant 8 bits [63:56] of the virtual address VA is valid as a part of the virtual address VA. In this case, a comparison result of the most significant 8 bits [63:56] is reflected in the TLB determination.

The TAG comparator 14C of the TLB unit 14 shown in FIG. 19 is divided into a comparator 146_1 which compares information [55:0] other than the key portion [63:56] of the virtual address VA and a comparator 146_2 which compares the key portion [63:56]. The TAG comparator 14C further includes an OR gate 149 which performs a logical OR operation of an output of the comparator 146_2 of the key portion [63:56] and the mode register 151, and outputs of the comparators 147 and 146_1 and the OR gate 149 are input to the AND gate 148. Operations of the TAG comparator 14C are as follows.

(1) When key check enable flag is valid (mode=1):

The most significant 8 bits [63:56] of the virtual address VA is valid as a key and cannot be regarded as a part of the virtual address VA. Therefore, in the TAG comparator 14C, the valid flag (mode=1) causes a match output (1) indicating a match to be output from the OR gate 149, and a comparison result by the comparator 146_2 of the key of the most significant 8 bits [63:56] of the virtual address VA is ignored. Accordingly, even in a case where the output of the comparator 146_2 is not a match, when outputs of the comparators 147 and 146_1 are both matches (1), a match of the TAG section 14A or, in other words, a hit in the TLB (TLB mch) is output from the AND gate 148.

(2) When key check enable flag is invalid (mode=0):

Since the most significant 8 bits [63:56] of the virtual address VA is invalid as a key and needs to be regarded as a part of the virtual address VA, in the TAG comparator 14C, the valid flag (mode=0) causes an output of the comparator 146_2 to be output from the OR gate 149 without modification, and a comparison result by the comparator 146_2 of an key section of the most significant 8 bits of the virtual address VA is reflected in the TLB match. Accordingly, when all outputs of the comparators 147, 146_1, and 146_2 match, a match of the TAG section 14A or, in other words, a hit in the TLB (TLB mch) is output from the AND gate 148.

### Advantageous Effects of Embodiment 1

With the processing device according to Embodiment 1, the key check circuit 153 compares an access key specified by the operation unit 12 and a memory key saved in the L1 data TAG 18 with each other. The access key and the memory key are area identification information generated by the OS 31 for each allocated area when a program executed by the CPU 10 including the operation unit 12 requests the OS 31 to allocate an area with an area allocation function. The OS 31 hands over the area identification information as an access key to the program together with a starting address of an allocated area. On the other hand, the OS 31 stores the area identification information in an entry of the memory key table 35 corresponding to the allocated area. In addition, when data of the allocated area is registered in the L1 data cache 19, the MKEY write control unit 36 stores the memory key stored in the memory key table 35 in the TAG section 18A of the L1 data TAG 18 corresponding to an address on the main memory 30 of the data to be registered. Therefore, the CPU 10 executing the program is capable of determining whether or not an access is from a program including an access key corresponding to the allocated area and is capable of detecting an unauthorized access. In other words, the CPU 10 can prevent memory destruction or a defect due to an unauthorized access to a memory area as a result of a defect or an incorrect code being present in the program. In addition, the CPU 10 can provide the OS 31 and the program with a function of detecting the unauthorized access by a hardware control circuit.

Furthermore, the CPU 10 includes the key table base address register 154 which stores a starting address of the memory key table 35 in the main memory 30. Therefore, the key table address generation circuit 155 can generate an address of a memory key corresponding to the data to be registered to the L1 data cache 19 based on the key table base address register 154. On the other hand, the OS 31 sets the starting address of the memory key table 35 to the key table base address register 154. By setting the starting address, the OS 31 causes the key table address generation circuit 155 to generate an address of the memory key and causes the MKEY write control unit 36 to register the memory key in the TAG section 18A of the L1 data TAG 18.

Furthermore, in Embodiment 1, a memory key and a memory key valid bit (MKEY-VLD) are registered in the TAG section 18A of the L1 data TAG 18. Since the TAG section 18A has smaller capacity than the L1 data cache 19, there is a degree of freedom in design for imparting an area for storing a memory key and a memory key valid bit (MKEY-VLD), and changes can be readily made.

### Embodiment 2

Embodiment 1 describes an example of a key check mechanism which detects an unauthorized access to the main memory 30 when executing an application program in a single process. In Embodiment 2, an example of a check mechanism will be described which detects an unauthorized access when an area of a memory is given a read only attribute or a read/write enabled attribute.

Specifically, the following processes are described as an example in Embodiment 2.
(1) Information processing by interprocess communication in which data is exchanged among a plurality of processes is assumed.
(2) A memory manager is introduced which has a function of generating an interprocess shared memory in response to a request from a plurality of processes.
(3) As a usage example of a shared memory used in interprocess communication, when exchanging data between processes, one of the processes executes read and write. In addition, the other process references the exchanged data on a read only basis.
(4) The OS 31 is capable of assigning read only access authority or read/write enabled access authority to each process accessing a generated shared memory. By introducing a key check mechanism similar to that of Embodiment 1, a process for which only read only is permitted can be prevented from erroneously performing writing and destroying data. However, the key check mechanism according to Embodiment 2 may be configured to check read only access authority or read/write enabled access authority in addition to the key check mechanism according to Embodiment 1.

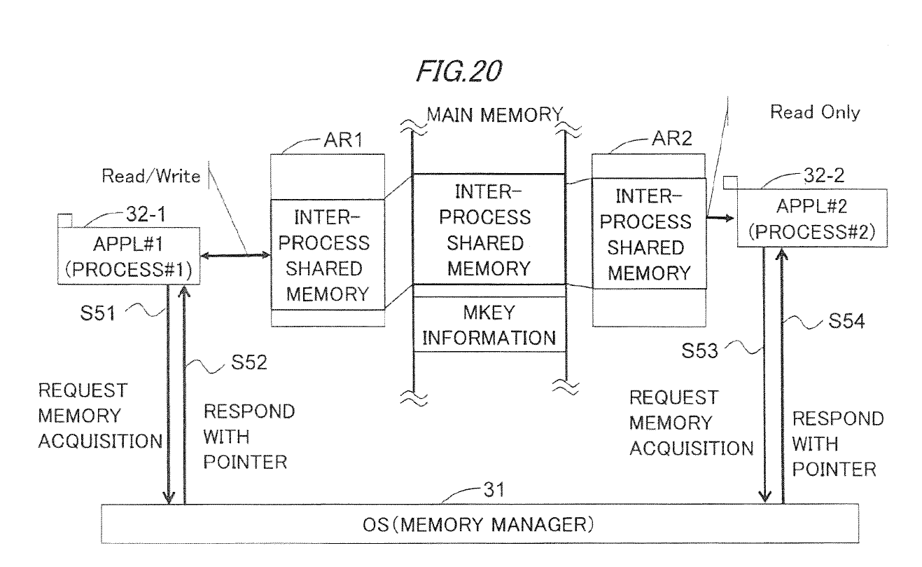

FIG. 20 is a diagram illustrating a relationship among processes according to Embodiment 2. For example, an application program APPL#1 32-1 executed by a process #1 makes an acquisition request for a read/write accessible memory to the memory manager of the OS 31 and acquires a pointer of an acquired starting address. An acquired memory area AR1 is considered an interprocess shared memory. The process #1 is capable of performing read/write access to the memory area AR1.

On the other hand, an application program APPL#2 32-2 executed by a process #2 makes an acquisition request for a read only accessible memory to the memory manager of the OS 31 and acquires a pointer of an acquired starting address. An acquired memory area AR2 is also considered an interprocess shared memory. The process #2 is capable of performing read access to the memory area AR2. Embodiment 2 describes an example of a check mechanism in an environment such as that shown in FIG. 20.

Moreover, a plurality of processes #1 and #2 are shown as example in FIG. 20. However, applications of the check mechanism by the CPU 10 are not limited to the example shown in FIG. 20. For example, the check mechanism according to Embodiment 2 described below can also be applied when a single process accesses an area of a different memory to which a read only attribute or a read/write enabled attribute is imparted. A read only attribute or a read/write enabled attribute is also referred to as access authority.

While the process #1 (APPL#1 32-1) and the process #2 (APPL#2 32-2) request access authority together with a memory acquisition request in FIG. 20, the present processing device is not limited to such processes. One of the processes such as the process #1 (APPL#1 32-1) may set access authority of the other process such as the process #2 (APPL#2 32-2) to a prescribed file, a prescribed shared memory, or the like to be handed over to the OS 31. The OS 31 may set access authority (a read only attribute or a read/write enabled attribute) to an allocated area in response to a memory acquisition request from the process #2 (APPL#2 32-2) in accordance with a setting of the process #1 (APPL#1 32-1). Alternatively, the OS 31 may set an attribute such as access authority to an area allocated in the process #1 (APPL#1 32-1) and/or the process #2 (APPL#2 32-2) in accordance with a setting of a third process which differs from the process #1 (APPL#1 32-1) and the process #2 (APPL#2 32-2).

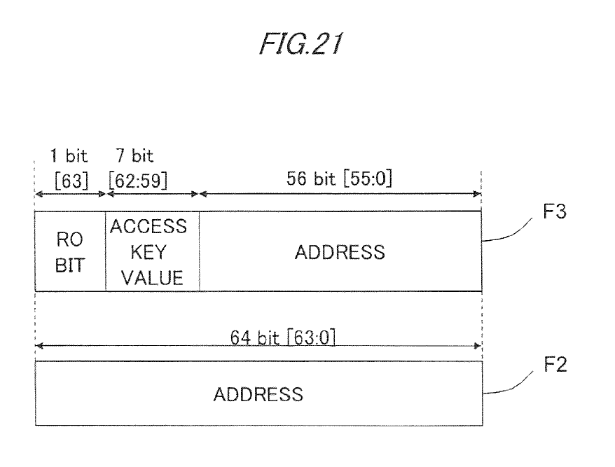

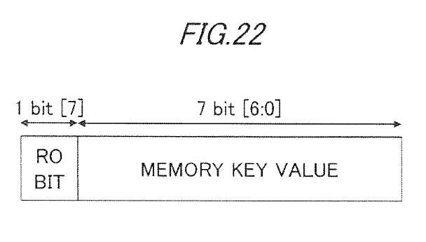

FIG. 21 illustrates a configuration of a virtual address according to Embodiment 2. In Embodiment 1, a format of a starting address which is returned by the OS 31 to the user program 32 is illustrated in FIG. 8. In Embodiment 2, the address format F1 in FIG. 8 is changed to an address format F3 shown in FIG. 22. In F3, an access key value is reduced to 7 bits as compared to F1, and a read only (RO) bit is added to a most significant position.

FIG. 22 is a diagram illustrating a configuration of a memory key according to Embodiment 2. A format of a memory key in the memory key table shown in FIG. 10 according to Embodiment 1 has been changed in Embodiment 2 as shown in FIG. 22. In FIG. 22, a memory key value in a memory table is reduced to 7 bits and a read only (RO) bit is added.

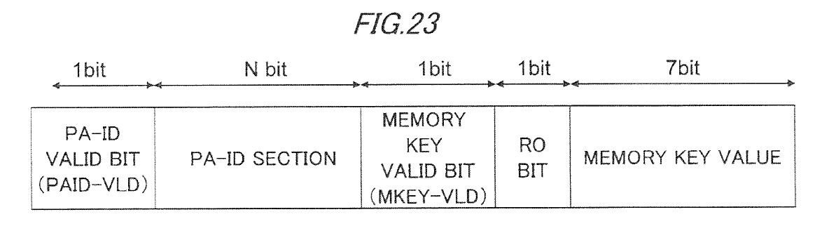

FIG. 23 is a diagram illustrating a format of one entry of the TAG section 18A according to Embodiment 2. A format of an entry of the TAG section 18A shown in FIG. 14 according to Embodiment 1 has been changed in Embodiment 2 as shown in FIG. 23. In FIG. 23, a memory key value is reduced to 7 bits and a read only (RO) bit is added.

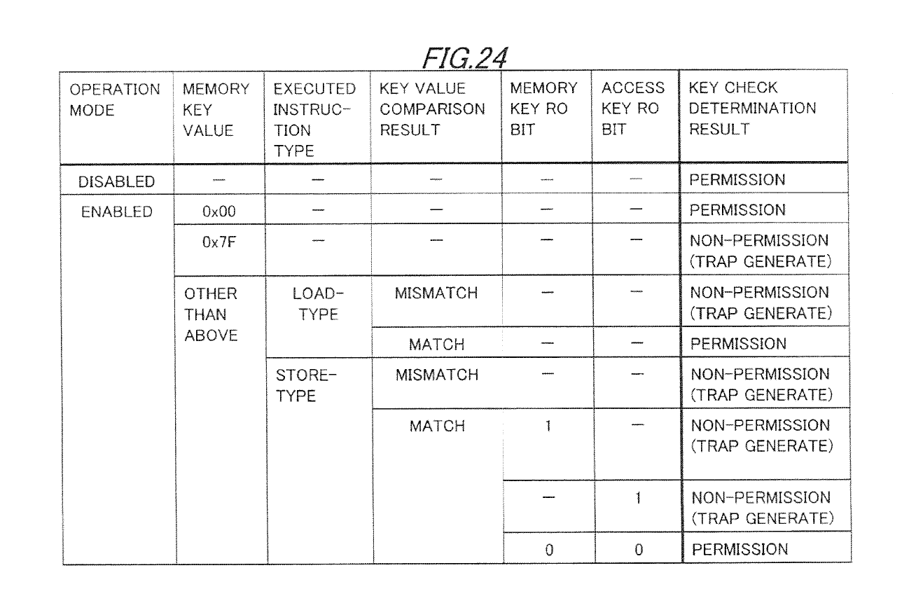

FIG. 24 is a diagram illustrating an operation truth table of a key check circuit 157 according to Embodiment 2. An operation truth table of the key check circuit 153 shown in FIG. 17 according to Embodiment 1 is changed in Embodiment 2 as shown in FIG. 24. Specifically, when a value of an RO bit of a memory key or an RO bit of an access key is 1, a non-permission trap is generated with respect to instructions of which an executed instruction type is a store type or, in other words, instructions which execute writing of data. On the other hand, with respect to instructions of which an executed instruction type is a load type or, in other words, instructions which execute reading of data, a non-permission trap is generated when a result of a comparison of a memory key value and an access key value is a mismatch in a similar manner to Embodiment 1. The key check circuit 157 is an example of a circuit which executes a process of further comparing, when executing an instruction to access a main memory, authority range information that is specified together with an address of an access destination and the access information with authority range information that is registered in the cache memory together with access object data and the identification information.

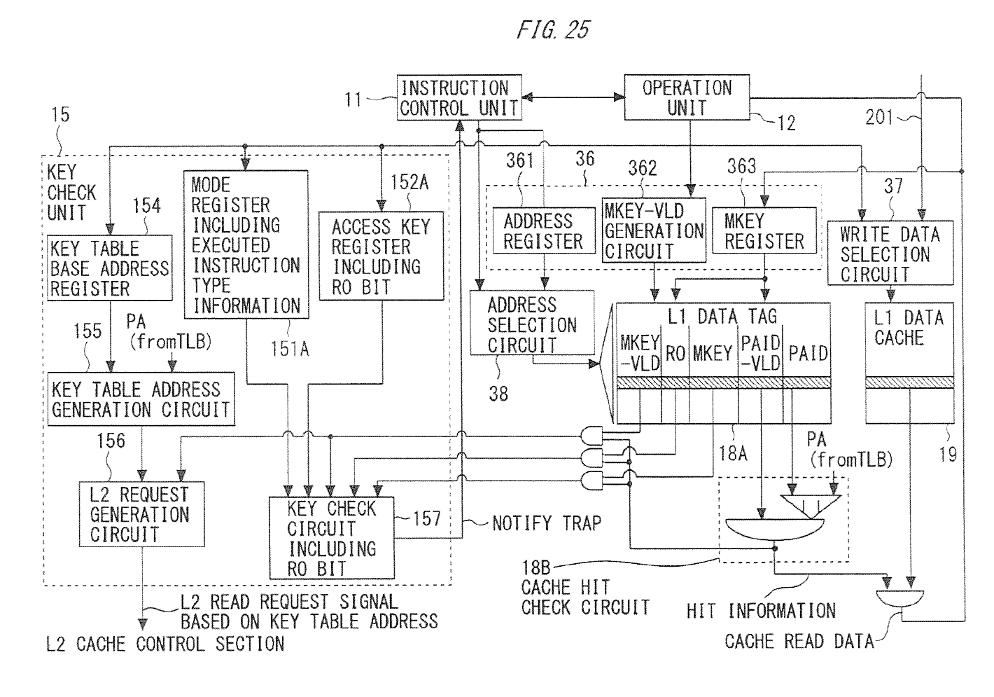

FIG. 25 is a diagram illustrating configurations of the L1 data TAG 18, the L1 data cache 19, and the key check unit 15 according to Embodiment 2. In Embodiment 2, executed instruction type information is added to a mode register 151A in addition to the key check enable bit described in Embodiment 1. The executed instruction type information is, for example, 1-bit information. Executed instruction type information with a value of 1 indicates that the operation unit 12 is to execute a store instruction and executed instruction type information with a value of 0 indicates that the operation unit 12 is to execute a load instruction. The operation unit 12 sets executed instruction type information to the mode register 151A upon execution of an instruction.

In addition, as shown in FIG. 21, an RO bit is added to an access key register 152A in addition to an access key upon memory access described in Embodiment 1. The user program 32 receives an RO bit as a part of a pointer of an area allocated by an area allocation function. In addition, the user program 32 accesses an allocated area using a pointer to which an RO bit and an access key are added. The operation unit 12 acquires an RO bit from an operand of a memory access instruction by an access by the user program 32 and sets the RO bit to the access key register 152A together with an access key. The RO bit is supplied to the key check circuit 157 together with an access key value stored in the access key register 152A.

Furthermore, an RO bit is added to the TAG section 18A in addition to the respective fields described in Embodiment 1. The RO bit is supplied to the key check circuit 157 together with a memory key value stored in the TAG section 18A. Upon area allocation due to a system call by an area allocation function, the OS 31 may generate an RO bit in accordance with a specification by the user program 32 and the like, configuration parameters of a prescribed file, or the like, and register the RO bit in an entry of the memory key table 35 together with area identification information. The MKEY write control unit 36 writes an RO bit and a memory key cached in the L1 data cache 19 from the memory key table 35 into the TAG section 18A in a similar procedure to Embodiment 1 (FIGS. 13, 18A, and 18B). The writing by the write data selection circuit 37 to the L1 data cache 19 and the writing of an RO bit by the MKEY write control unit 36 to the TAG section 18A are examples of “when registering data stored in the main memory to the cache memory, acquiring authority range information stored in association with an area in which the data to be registered is stored on the main memory and registering the authority range information together with the data to be registered in the cache memory”. An RO bit is an example of authority range information.

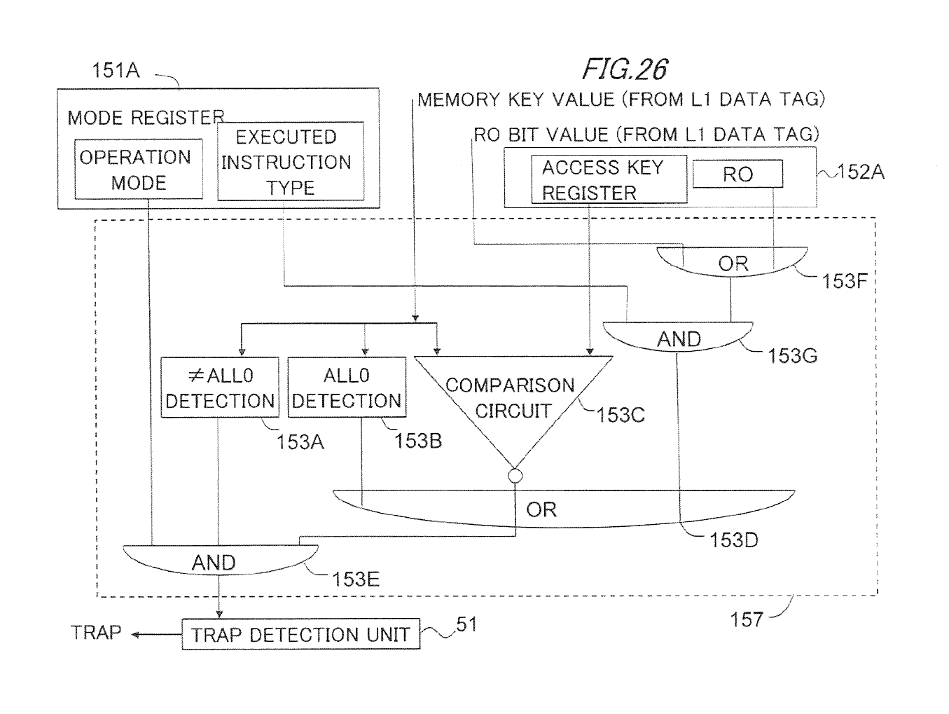

FIG. 26 illustrates a configuration of the key check circuit 157 according to Embodiment 2. Compared to the key check circuit 153 according to Embodiment 1 (FIG. 16), an OR gate 153F and an AND gate 153G are added to the key check circuit 157 according to Embodiment 2. In addition to the various types of information described in Embodiment 1, the key check circuit 157 receives executed instruction type information from the mode register 151A, an RO bit attached to an access key value from the access key register 152A, and an RO bit attached to a memory key value from the TAG section 18A.

The OR gate 153F executes a logical OR of the RO bit attached to the access key value from the access key register 152A and the RO bit attached to the memory key value from the TAG section 18A. In addition, the AND gate 153G executes a logical AND of the executed instruction type information from the mode register 151A and an output of the OR gate 153F.

In addition, when an operation mode of the mode register 151A is key check mechanism enabled and the memory key value is other than ALL0, the key check circuit 157 executes a determination based on an RO bit in addition to a determination based on an access key. Specifically, when the executed instruction type is a store-type instruction and either the RO bit from the L1 data TAG 18 is 1 or the RO bit or the access key bit which is handed over together with the access key from the effective address generator 12A is 1, a trap request is generated by the OR gate 153F and the AND gate 153G. A circuit including the OR gate 153F and the AND gate 153G is an example of “a determination circuit which determines, when executing an instruction to access a main memory, whether or not a type of the instruction to perform the access, authority range information that is specified together with an address of an access destination and authority range information that is registered in the cache memory together with access object data satisfy prescribed conditions”.

In other words, the key check circuit 157 checks whether or not a key check is performed and a trap is generated in accordance with the operation truth table shown in FIG. 24. When trap generation conditions are satisfied, the key check circuit 157 makes a request to the trap detection unit 51 to generate a trap. When receiving the request to generate a trap, the trap detection unit 51 notifies the OS 31 of a trap via the instruction sequence control unit 11A (refer to FIG. 11). In FIG. 26, a notification of a trap from the trap detection unit 51 to the OS 31 is an example of stopping execution of an instruction for accessing the main memory when prescribed conditions are satisfied.

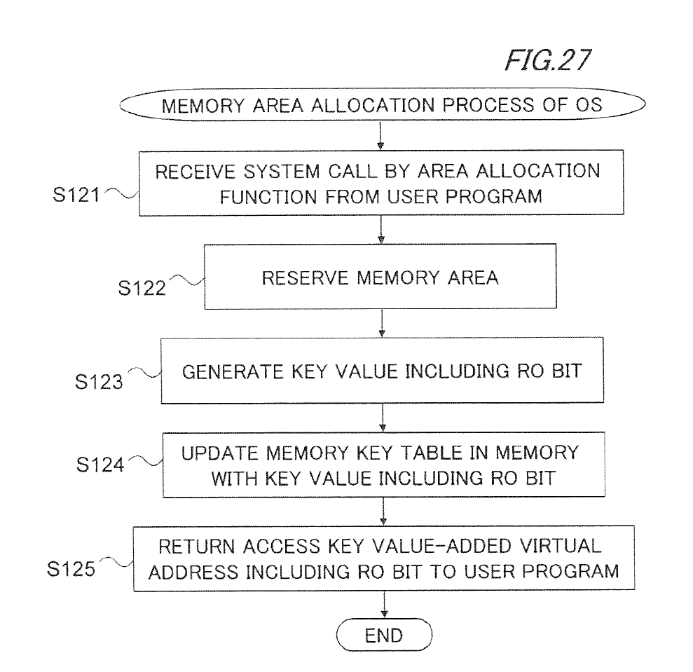

FIG. 27 is a flow chart illustrating processes of the OS 31 which are executed by an information processing apparatus including the CPU 10 according to Embodiment 2. The OS 31 receives a system call by an area allocation function from a user program that is an application program or the like (S121). The OS 31 reserves a memory area in accordance with the system call in S121 (S122). Next, the OS 31 generates a key value including an RO bit (S123). In this case, the RO bit may be specified by the user program having called the area allocation function in S121. Alternatively, a program other than the user program having called the area allocation function in S121 may specify the RO bit to a process of the user program having called the area allocation function in S121 with a prescribed file, a shared memory, or the like. The OS 31 may generate a key value including an RO bit in accordance with the specification in the prescribed file, the shared memory, or the like in response to a system call by an area allocation function from each process.

Next, the OS 31 updates the memory key table 35 on the main memory 30 with the key value including the RO bit (S124). Subsequently, the OS 31 returns an access key value-added virtual address which includes the RO bit to the user program (S125). In subsequent processes, the user program may access an allocated area using the access key value-added virtual address which includes the RO bit. The process of S124 is an example of, when executing a process of allocating an area on the main memory in accordance with a request from a first process, storing authority range information indicating a range of access authority to the allocated area in the main memory in association with the allocated area. The process of S125 is an example of handing over the authority range information together with an address of the allocated area to the first process.

### Advantageous Effects of Embodiment 2

As described above, in Embodiment 2, the OS 31 uses a most significant bit of an access key value as an RO bit in response to a system call from a memory area allocation function. When returning the access key value to the user program 32, the OS 31 hands over an RO bit with a value of 1 when the user program 32 only permits reading (does not permit writing). Alternatively, when the user program 32 permits both writing and reading, the OS 31 hands over an RO bit with a value of 0.

When the user program 32 not permitted to write in an allocated memory area performs a read from the memory area, the read instruction is normally executed as shown in FIG. 24. On the other hand, when the user program 32 not permitted to write in the same memory area performs a write to the memory area, a trap is generated with respect to the write instruction and the instruction is not executed as shown in FIG. 24. As a result, destruction of the memory is prevented.

It is to be noted that, while an RO bit is described as an example of access authority in Embodiment 2, processing of the CPU 10 is not limited to an RO bit. In addition, an RO bit is set to a most significant bit portion of an access key value and a memory key value in Embodiment 2. However, access authority such as an RO bit may be separated from an access key value and a memory key value and may be independently embedded in a virtual address.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A processing device to access a main memory, the processing device comprising:
a cache memory configured to temporarily register data stored in the main memory;
a registration circuit that, when registering the data stored in the main memory to the cache memory, acquires identification information set in association with an area in that the data to be registered is stored in the main memory, and registers, in the cache memory, the identification information together with the data to be registered;
a comparison circuit that, when executing an instruction to access the main memory, compares access information specified together with an address of an access destination and identification information registered together with access object data in the cache memory, with each other; and
an access limitation circuit that stops execution of the instruction to access the main memory in accordance with a result of the comparison.

2. The processing device according to claim 1, further comprising an execution unit configured to execute a second process that, when executing a process of allocating an area on the main memory in accordance with a request from a first process, generates identification information for identifying the area to be allocated and stores the generated identification information in a prescribed area of the main memory, and hands over the generated identification information together with an address of the allocated area to the first process as access information that is to be specified when accessing the allocated area.

3. The processing device according to claim 1, wherein
the identification information is stored in an element string on the main memory that corresponds to a fixed-length block sequence of the main memory, and
the processing device further comprises an address register that specifies a starting address of the element string in the main memory.

4. The processing device according to claim 1, further comprising:
an execution unit configured to execute a second process that, when executing a process of allocating an area on the main memory in accordance with a request from a first process, stores authority range information, that indicates a range of access authority to the area to be allocated, in the main memory in association with the area to be allocated, and hands over the authority range information together with an address of the allocated area to the first process, wherein
the registration circuit acquires, when registering data stored in the main memory to the cache memory, authority range information stored in association with an area in that the data to be registered is stored on the main memory, and registers, in the cache memory, the authority range information together with the data to be registered,
the comparison circuit includes a determination circuit that, when executing an instruction to access the main memory, determines whether or not a type of the instruction to perform the access, authority range information specified together with the address of the access destination and authority range information registered together with access object data in the cache memory satisfy prescribed conditions, and
the access limitation circuit stops execution of an instruction to access the main memory when the prescribed conditions are satisfied.

5. The processing device according to claim 1, wherein the registration circuit stores the identification information in a tag section that stores tag information for reading the access object data in the cache memory.

6. An information processing apparatus, comprising:
a main memory; and
a processing device to execute a process including an instruction sequence stored in the main memory and to access data stored in the main memory,
the processing device including:
an execution unit configured to execute a second process that, when executing a process of allocating an area on the main memory in accordance with a request from a first process, generates identification information for identifying the area to be allocated and stores the identification information in a prescribed area of the main memory, and hands over the identification information together with an address of the allocated area to the first process as access information that is to be specified when accessing the allocated area;
a cache memory configured to temporarily register data in the main memory;
a registration circuit that, when registering the data stored in the main memory to the cache memory, acquires identification information set in association with an area in that the data to be registered is stored on the main memory, and registers, in the cache memory, the identification information together with the data to be registered;
a comparison circuit that, when executing an instruction to access the main memory, compares access information specified together with an address of an access destination and identification information registered together with access object data in the cache memory, with each other; and
an access limitation circuit that stops execution of the instruction to perform the access in accordance with a result of the comparison.

7. A control method of a processing device including a cache memory configured to temporarily register data stored in a main memory, the control method comprising:
acquiring, when registering the data stored in the main memory to the cache memory, identification information set in association with an area in that the data to be registered is stored on the main memory, and registering, in the cache memory, the identification information together with the data to be registered;
comparing, when executing an instruction to access the main memory, access information specified together with an address of an access destination and identification information registered together with access object data in the cache memory, with each other; and
stopping execution of the instruction to access the main memory in accordance with a result of the comparison.
